(19) United States
(12) Patent Application Publication
(10) Pub. No.: US 2025/0031115 A1
(43) Pub. Date: Jan. 23, 2025

(54) METHOD FOR NEIGHBOR CELL MEASUREMENT IN NTN, AND DEVICE

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN); Xinlei YU, Dongguan (CN)

(21) Appl. No.: 18/903,314

(22) Filed: Oct. 1, 2024

Related U.S. Application Data
(63) Continuation of application No. PCT/CN2022/090635, filed on Apr. 29, 2022.

(51) Int. Cl. H04W 36/00; H04W 84/06

(52) U.S. Cl. CPC H04W 36/0085; H04W 84/06

(57) ABSTRACT

Provided is a method for neighbor cell measurement in an NTN. The method is applicable to a terminal. The method includes: initiating measurement of neighbor cells based on whether at least one of a distance or a distance variation between the terminal and a serving cell reference point meets a terminal position-based evaluation criterion.

### CROSS-REFERENCE TO RELATED APPLICATION

This application is a continuation application of international application No. PCT/CN2022/090635, filed on Apr. 29, 2022, the entire contents of which are incorporated herein by reference.

### TECHNICAL FIELD

The present disclosure relates to the technical field of communications, and in particular, relates to a method and apparatus for neighbor cell measurement in a non-terrestrial network (NTN), and a device and a storage medium thereof.

### BACKGROUND

In non-terrestrial network (NTN) systems, a terminal performs neighbor cell measurement based on a measurement initiation threshold configured by a network device.

### SUMMARY

Embodiments of the present disclosure provide a method and apparatus for neighbor cell measurement in an NTN, and a device and a storage medium. The technical solutions are as follows.

According to some embodiments of the present disclosure, a method for neighbor cell measurement in an NTN is provided. The method is applicable to a terminal and includes:
initiating measurement of neighbor cells based on whether a distance and/or a distance variation between the terminal and a serving cell reference point meets a terminal position-based evaluation criterion.

According to some embodiments of the present disclosure, a method for neighbor cell measurement in an NTN is provided. The method is applicable to a terminal and includes:
initiating measurement of neighbor cells prior to a cell service stop time, wherein the cell service stop time indicates a time when a serving cell in which the terminal is located stops providing services to a coverage area.

According to some embodiments of the present disclosure, a terminal is provided. The terminal includes a processor.

The processor is configured to initiate measurement of neighbor cells based on whether a distance and/or a distance variation between the terminal and a serving cell reference point meets a terminal position-based evaluation criterion.

### BRIEF DESCRIPTION OF THE DRAWINGS

For clearer descriptions of the technical solutions according to the embodiments of the present disclosure, the accompanying drawings required for describing the embodiments are briefly introduced hereinafter. Apparently, the accompanying drawings in the following description show merely some embodiments of the present disclosure, and those of ordinary skill in the art may still derive other drawings from these accompanying drawings without creative efforts.

FIG. 1 is a network architecture diagram of a transparent payload satellite according to some exemplary embodiments of the present disclosure;

FIG. 2 is a network architecture diagram of a regenerative payload satellite according to some exemplary embodiments of the present disclosure;

FIG. 3 is a schematic diagram of the near-far effect in different scenarios according to some exemplary embodiments of the present disclosure;

FIG. 4 is a flowchart of a method for neighbor cell measurement in an NTN according to some exemplary embodiments of the present disclosure;

FIG. 5 is a flowchart of a method for neighbor cell measurement in an NTN according to some exemplary embodiments of the present disclosure;

FIG. 6 is a flowchart of a method for neighbor cell measurement in an NTN according to some exemplary embodiments of the present disclosure;

FIG. 7 is a flowchart of a method for neighbor cell measurement in an NTN according to some exemplary embodiments of the present disclosure;

FIG. 8 is a flowchart of a method for neighbor cell measurement in an NTN according to some exemplary embodiments of the present disclosure;

FIG. 9 is a schematic diagram of performing the measurement of neighbor cells according to some exemplary embodiments of the present disclosure;

FIG. 10 is a flowchart of a method for neighbor cell measurement in an NTN according to some exemplary embodiments of the present disclosure;

FIG. 11 is a flowchart of a method for neighbor cell measurement in an NTN according to some exemplary embodiments of the present disclosure;

FIG. 12 is a flowchart of a method for neighbor cell measurement in an NTN according to some exemplary embodiments of the present disclosure;

FIG. 13 is a schematic diagram of performing the measurement of neighbor cells according to some exemplary embodiments of the present disclosure;

FIG. 14 is a flowchart of a method for neighbor cell measurement in an NTN according to some exemplary embodiments of the present disclosure;

FIG. 15 is a flowchart of a method for neighbor cell measurement in an NTN according to some exemplary embodiments of the present disclosure;

FIG. 16 is a schematic diagram of performing the measurement of neighbor cells according to some exemplary embodiments of the present disclosure;

FIG. 17 is a schematic diagram of an apparatus for neighbor cell measurement in an NTN according to some exemplary embodiments of the present disclosure;

FIG. 18 is a schematic diagram of an apparatus for neighbor cell measurement in an NTN according to some exemplary embodiments of the present disclosure;

FIG. 19 is a schematic diagram of an apparatus for neighbor cell measurement in an NTN according to some exemplary embodiments of the present disclosure;

FIG. 20 is a schematic diagram of an apparatus for neighbor cell measurement in an NTN according to some exemplary embodiments of the present disclosure; and

FIG. 21 is a schematic structural diagram of a communication device according to some exemplary embodiments of the present disclosure.

### DETAILED DESCRIPTION

For clearer descriptions of the objectives, technical solutions, and advantages of the present disclosure, embodiments of the present disclosure are further described in detail below with reference to the accompanying drawings.

Currently, with the increasing demands for speed, latency, high mobility, and energy efficiency, and the diversity and complexity of services in future life, the 3^{rd} Generation Partnership Project (3GPP) international standards organization has started to develop the 5^{th} generation (5G) communication. The main application scenarios of 5G include: enhanced mobile broadband (eMBB), ultra-reliable low-latency communications (URLLC), and massive machine-type communications (mMTC).

A new radio (NR) may also be deployed independently, and for reduction of radio signaling, quick recovery of wireless connections, and quick recovery of data services in a 5G network environment, a new radio resource control (RRC) state, i.e., an RRC_INACTIVE state, is defined. This state is different from an RRC_IDLE state and an RRC_ACTIVE state.

RRC_IDLE: Mobility is cell selection and reselection based on a terminal, paging is initiated by the terminal, and a paging region is configured by the terminal. Neither a terminal access stratum (AS) context nor an RRC connection is present on a network device.

RRC_CONNECTED: An RRC connection is present, and a terminal AS context is present on both the network device and the terminal. The network device determines the position of the terminal based on the cell level, and the mobility is the mobility controlled by the network device. Unicast data may be transmitted between the terminal and the network device.

RRC_INACTIVE: Mobility is cell selection and reselection based on the terminal, a connection is present between a core network (CN) and an NR, which may be abbreviated as a CN-NR connection, a terminal AS context is present on a network device, paging is triggered by a radio access network (RAN), a paging region based on the RAN is managed by the RAN, and the network device determines the position of the terminal based on the RAN-based paging region level.

Prior to detailed description of the technical solutions according to the present disclosure, the relevant knowledge involved in the present disclosure is first explained below:

### Radio Resource Management (RRM) Measurement for Terminals in a Non-Connected State in Narrow Band Internet of Things (NB-IoT):

Terminals (user equipments, UEs) in a non-connected state need to perform the RRM measurement on the serving cell and other neighbor cells based on network configurations to support mobility operations, such as cell reselection.

Illustratively, the UE in a non-connected state continuously measures the serving cell. In NB-IoT, a relaxation mechanism for the neighbor cell measurement is introduced for stationary terminals to further meet the power-saving requirements of the terminal. For the measurement relaxation criterion introduced for neighbor cell measurement relaxation, the network device configures the evaluation duration of the narrowband reference signal received power (NRSRP) variation as well as the variation value threshold of the reference signal received power (RSRP). The evaluation duration may be indicated by TSearchDeltaP, and the RSRP variation value threshold may be indicated by SSearchDeltaP.

In the case that the RSRP variation of the UE in the serving cell is less than SSearchDeltaP within a period of TSearchDeltaP, the UE is considered to meet the measurement relaxation criterion.

Illustratively, within a period of TSearchDeltaP, the following condition is met:

(SrxlevRef−Srxlev)<SSearchDeltaP <Formula 1>.

Srxlev represents the current Srxlev measurement value of the serving cell, and SrxlevRef represents the reference Srxlev value of the serving cell.

In the case that the UE selects or reselects to a new cell, or (Srxlev−SrxlevRef)>0, or the UE does not meet <Formula 1> continuously for the duration of TSearchDeltaP, the UE sets SrxlevRef to the current Srxlev measurement value of the serving cell. Subsequently, upon completion of cell selection/reselection, the UE needs to perform the normal RRM measurement for at least a period of TSearchDeltaP.

In some embodiments, in the case that the UE meets the measurement relaxation criterion, the measurement interval of the UE for neighbor cells is increased to 24 hours.

### RRM Measurement for UEs in a Connected State in NR:

Illustratively, NB-IoT UEs do not support the RRM measurement in the connected state. In the case that the channel quality of the connected NB-IoT in the serving cell deteriorates, mobility management is performed through radio link failure (RLF) and the RRC re-establishment process.

In the case that an RLF is triggered by the UE, it first needs to select a suitable cell through searching and measuring, and then initiate an RRC connection re-establishment in the cell. To save time for the UE to select and re-establish a cell upon trigger of an RLF, a neighbor cell measurement mechanism for connected state UEs may be introduced for NB-IoT UEs.

For the neighbor cell measurement of connected state UEs, the network configures the s-measure criterion over system messages, and the network may also configure the UE mobility state evaluation criterion for the terminal. The UE then determines, based on the s-measure criterion and the UE mobility state evaluation criterion, whether to perform the measurement of neighbor cells as follows.

In the case that the UE enters the RRC connected state, if the network has configured the UE mobility state evaluation criterion, then:
The UE sets the NRSRP reference value (NRSRP Ref) to the most recently measured NRSRP on the serving cell for cell selection/reselection;
In the case that the UE did not meet the neighbor cell measurement relaxation criterion prior to entering the RRC connected state, the UE starts the corresponding timer, which may be indicated by T3AB. A and B may be the same integer or different integers, and the value for A and B ranges from 0 to 9. It should be understood that T3AB may also be expressed in other ways, such as T3XX, and “XX” is used to replace the same or different integers.

For a UE in the connected state, assuming that the measurement result of the UE on the measured carrier is NRSRP, in the case that the network has configured the UE mobility state evaluation criterion, then:
In the case that (NRSRP Ref−(NRSRP−PowerOffsetNonAnchor))>s-MeasureDeltaP, the UE sets NRSRP Ref=NRSRP−PowerOffsetNonAnchor and starts or restarts T3AB.

In the case that the network has not configured the UE mobility state evaluation criterion, or T3AB is running:
In the case that (NRSRP−PowerOffsetNonAnchor)<s-MeasureIntra, the UE performs the measurement on intra-frequency neighbor cells.
In the case that (NRSRP−PowerOffsetNonAnchor)<s-MeasureInter, the UE performs the measurement on inter-frequency neighbor cells.

### Related Background of Non-Terrestrial Network (NTN):

Currently, 3GPP is researching the NTN technology, which generally provides communication services to ground users over satellite communication. Compared to ground-based cellular network communication, satellite communication has many unique advantages. Firstly, satellite communication is not restricted by subscriber positions. For example, typical terrestrial communications cannot cover areas such as oceans, mountains, and deserts where communication devices cannot be deployed, or regions where communication coverage is not provided considering sparse population. However, for satellite communication, since a single satellite covers large ground areas and orbits the Earth, theoretically, every corner of the Earth can be covered by satellite communication. Secondly, satellite communication has significant social value. Satellite communication covers remote mountainous areas, poor and underdeveloped countries or regions at lower costs, allowing people there to enjoy advanced voice communication and mobile Internet. This helps bridge the gap with developed regions in accessing the digital technology and resources and promotes development in these regions. Thirdly, satellite communication features a longer communication distance, and increasing communication distance does not significantly increase communication costs. Lastly, satellite communication is highly stable and not subject to natural disasters.

Communication satellites are categorized based on their orbital altitude into different types such as low-Earth orbit (LEO) satellites, medium-Earth orbit (MEO) satellites, geostationary Earth orbit (GEO) satellites, high elliptical orbit (HEO) satellites, or the like. Currently, the research focuses on LEO and GEO satellites.
1. LEO: The altitude of the LEO satellite ranges from 500 km to 1500 km, and the corresponding orbital period ranges from approximately 1.5 to 2 hours. The signal propagation latency for single-hop communication between users is generally less than 20 ms. The maximum satellite visibility time is 20 minutes. The signal propagation distance is short, with fewer link losses, and low requirements for transmitting power at terminals.
2. GEO: GEO satellites have an orbit altitude of 35786 km and a rotation period around the Earth of 24 hours. The signal propagation latency for single-hop communication between users is generally 250 ms.

To ensure satellite coverage and increase the overall system capacity of the satellite communication system, satellites use multiple beams to cover the ground, and one satellite may form dozens or even hundreds of beams to cover the ground; and one satellite beam may cover a ground area with a diameter ranging from tens to hundreds of kilometers.

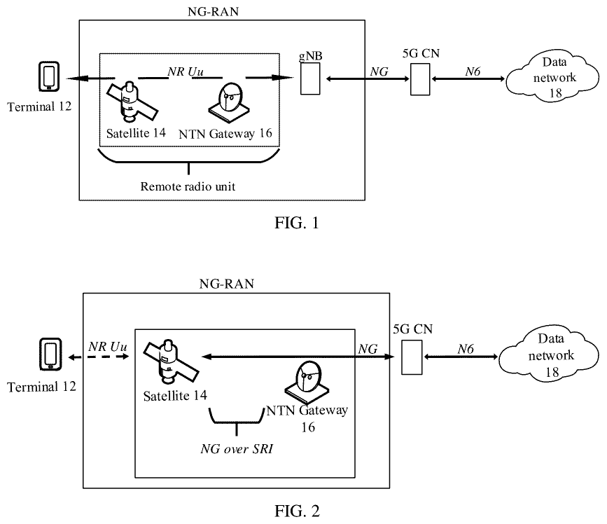

Currently, two types of satellites are considered in 3GPP. One is transparent payload satellite, as shown in FIG. 1, and the other is regenerative payload satellite, as shown in FIG. 2.

A feeder link refers to a radio link between the satellite 14 and the NTN gateway 16. The NTN gateway typically deployed on the ground.

Illustratively, an NTN network consists of the following elements:
One or more gateways: are configured to connect satellites to the terrestrial public network.
A feeder link: is a link for communication between the gateway and the satellite.
A service link: is a link for communication between the terminal and the satellite.
Satellites: in terms of functionality, are categorized into two types: transparent payload and regenerative payload satellites.

The transparent payload only provides radio frequency filtering, and frequency conversion and amplification functions, and only provides transparent payload of signals without altering the waveform of the signal.

In addition to radio frequency filtering, and frequency conversion and amplification functions, the regenerative payload also provides demodulation/decoding, routing/switching, and encoding/modulation functions. It implements part or all of the functions of a base station.
An inter-satellite link (ISL): is present in scenarios involving regenerative payloads.

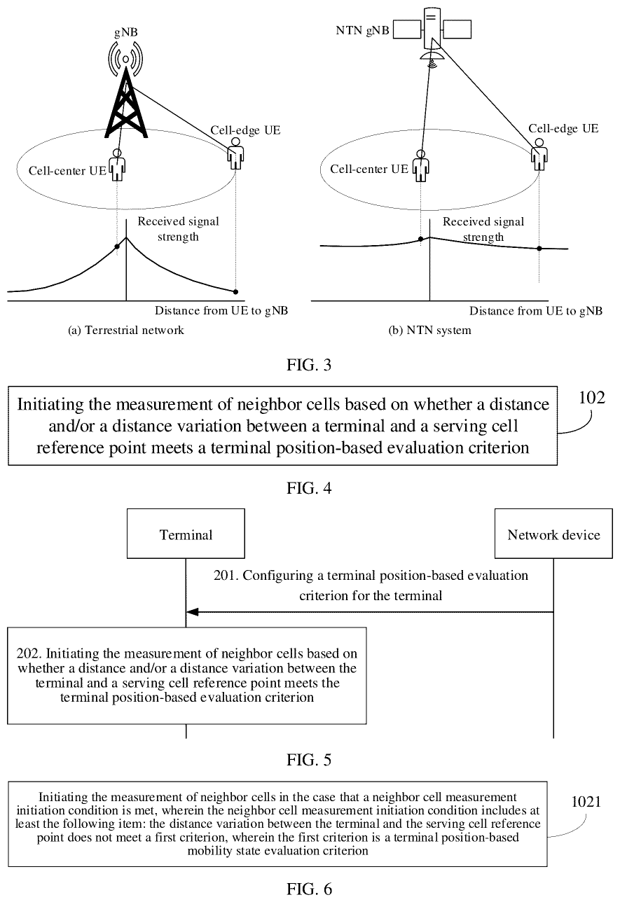

FIG. 3 illustrates a schematic diagram of the near-far effect in different scenarios.

As shown schematically in FIG. 3(a), in a terrestrial network, the reference signal received power (N)RSRP when a UE is at the center of a cell is significantly higher than the (N)RSRP when the UE is at the edge of the cell. Due to the evident “near-far effect”, whether the neighbor cell measurement initiation condition is met may be determined based on the (N)RSRP measurement. That is, in the case that the network has configured the s-measure criterion, the UE may determine whether its channel condition is not good enough by measuring the (N)RSRP of the serving cell. In the case that the network has configured the UE mobility evaluation criterion, the UE may determine whether it does not meet the low mobility or stationary state based on its (N)RSRP variation on the serving cell.

As shown schematically in FIG. 3(b), in an NTN system, the difference in RSRP between a UE at the center of a cell and a UE at the edge of a cell is not significant. In the case that whether the UE meets the s-measure criterion or/and the UE mobility evaluation criterion is determined based on the current RSRP measurement, it is difficult for the network to set an appropriate RSRP threshold, and moreover, due to measurement errors in RSRP, it is likely to cause the UE to perform inappropriate measurement operations. For example, in the case that the network has configured the s-measure criterion, for a user at the center of the cell, a lower measured RSRP would lead to the initiation of the measurement of neighbor cells, which increases unnecessary terminal power consumption. For a user at the edge of the cell, a higher measured RSRP would lead to a failure to initiate the measurement of neighbor cells, upon trigger of the RLF by the UE, the RRC re-establishment time is increased, thereby affecting the user experience.

Using the threshold being a reference signal received power (RSRP) threshold as an example, in NTN systems, no significant difference is present between the RSRP when the terminal is at the center of a serving cell and the RSRP when the terminal is at the edge of the serving cell, and thus it is difficult for the network device to configure an appropriate RSRP threshold for the terminal. Additionally, upon configuration of the RSRP threshold by the network device, due to errors in RSRP measurement, the terminal may perform unnecessary or incorrect measurement operations, thus failing to meet the mobility management requirements of the terminal.

Based on the above content, embodiments of the present disclosure provide a method for neighbor cell measurement in an NTN to meet the mobility management requirements of the terminal. FIG. 4 illustrates a flowchart of a method for neighbor cell measurement in an NTN according to some exemplary embodiments of the present disclosure. The method is applicable to a terminal and includes the following process.

In process 102, the measurement of neighbor cells is initiated based on whether the distance and/or the distance variation between a terminal and a serving cell reference point meets the terminal position-based evaluation criterion.

The distance and/or the distance variation between the terminal and the serving cell reference point is determined according to a distance reference value. The distance reference value is represented by Dref. In some embodiments, the distance reference value is configured by the network device for the terminal or autonomously determined by the terminal.

For example, the terminal determines the distance reference value as the real-time distance or the most recently measured distance. The real-time distance is the distance between the real-time position of terminal and the serving cell reference point, and the most recently measured distance is the distance between the most recently acquired effective terminal position of terminal and the serving cell reference point. The real-time position of terminal refers to the position of the terminal at the time point of determining the distance and/or the distance variation between the terminal and the serving cell reference point. The most recently acquired effective terminal position of terminal refers to the most recently acquired terminal position of the terminal before the time point of determining the distance and/or the distance variation between the terminal and the serving cell reference point.

In some embodiments, in NB-IoT, the serving cell reference point is the reference point corresponding to the anchor carrier.

The terminal position-based evaluation criterion is configured by the network device for the terminal. In the case of configuring the terminal position-based evaluation criterion, the network device configures the evaluation duration and/or the threshold corresponding to the evaluation criterion for the terminal to facilitate the determination of the terminal.

Illustratively, the terminal position-based evaluation criterion may be the terminal position-based mobility state evaluation criterion or the terminal position-based s-measure criterion. The mobility state evaluation criterion is used to evaluate the mobility state of the terminal, and the s-measure criterion is used to determine whether the terminal is at the edge of the cell.

Using a scenario where the terminal position-based evaluation criterion is the first criterion as an example, process 102 may be implemented as follows.

In the case that the neighbor cell measurement initiation condition is met, the measurement of neighbor cells is initiated.

The neighbor cell measurement initiation condition includes at least the following item: the distance variation between the terminal and the serving cell reference point does not meet the first criterion, wherein the first criterion is a terminal position-based mobility state evaluation criterion.

In some embodiments, in the case that the first criterion corresponds to the first evaluation duration and the first threshold, and the distance variation between the terminal and the serving cell reference point is less than or equal to the first threshold within the first evaluation duration, it is determined that the distance variation meets the first criterion. The distance variation is determined based on the distance reference value.

The first evaluation duration is represented by t-MeasureDeltaD. The first threshold is the distance variation threshold corresponding to the first criterion, which is represented by s-MeasureDeltaD. The distance variation indicates the variation of the distance between the terminal and the serving cell reference point relative to the distance reference value, including both increase and decrease in distance.

In some embodiments, the distance variation is determined based on the distance reference value. The distance reference value is configured by the network device for the terminal or autonomously determined by the terminal, and the distance reference value is represented by Dref.

In some embodiments, in the case that the first criterion corresponds to a timer used to evaluate the mobility state of the terminal, the duration of the first timer corresponding to the first criterion is the first evaluation duration. The first timer corresponding to the first criterion is represented by T3XY. X and Y are the same integer or different integers, and the value for X and Y ranges from 0 to 9. It should be understood that T3XY may also be expressed in other ways, such as T3YY, “YY” is used to replace the same or different integers.

Based on the above content, the distance variation meets the first criterion under the following condition: within the first evaluation duration and the distance variation between the terminal and the serving cell reference point is less than or equal to the first threshold. The “within the first evaluation duration” may be implemented as the first timer corresponding to the first criterion is running. It should be understood that, except for the above condition, any other situation would be considered as the distance variation not meeting the first criterion. For example, in the case that the first timer corresponding to the first criterion is running, it is determined that the distance variation does not meet the first criterion. For another example, in the case that the first timer corresponding to the first criterion is running and the distance variation between the terminal and the serving cell reference point is greater than the first threshold, it is determined that the distance variation does not meet the first criterion.

In some embodiments, the neighbor cell measurement initiation condition further includes at least one of the following items: The first timer corresponding to the first criterion is running, and the terminal meets the measurement initiation condition corresponding to the s-measure criterion; the second timer corresponding to the second criterion is running, and the terminal meets the measurement initiation condition corresponding to the s-measure criterion; and the first timer corresponding to the first criterion is running, the second timer corresponding to the second criterion is running, and the terminal meets the measurement initiation condition corresponding to the s-measure criterion.

The second criterion is the channel quality-based mobility state evaluation criterion, and the second timer corresponding to the second criterion is represented by T3AB. For example, the second criterion is the mobility state evaluation criterion based on (N)RSRP.

In some embodiments, the measurement initiation conditions corresponding to the s-measure criterion are as follows: the distance between the terminal and the serving cell reference point does not meet the third criterion; the terminal does not meet the fourth criterion; and the distance between the terminal and the serving cell reference point does not meet the third criterion, and the terminal does not meet the fourth criterion. The third criterion is the terminal position-based s-measure criterion, and the fourth criterion is the channel quality-based s-measure criterion. The related descriptions of the third criterion and the fourth criterion will be elaborated below and are not specifically described here.

In some embodiments, the first timer corresponding to the first criterion is different from or the same as the second timer corresponding to the second criterion. In the case that the first timer corresponding to the first criterion is different from the second timer corresponding to the second criterion, the first criterion uses the T3XY timer, and the second criterion uses the T3AB timer. In the case that the first timer corresponding to the first criterion is the same as the second timer corresponding to the second criterion, the first criterion and the second criterion jointly use the T3AB timer.

A and B are the same integer or different integers, and the value for A and B ranges from 0 to 9; X and Y are the same integer or different integers, and the value for X and Y ranges from 0 to 9. It should be understood that T3XY may also be expressed in other ways, such as T3YY, where “YY” is used to replace the same or different integers; T3AB may also be expressed in other ways, such as T3XX, where “XX” is used to replace the same or different integers.

Using a scenario where the terminal position-based evaluation criterion is the third criterion as an example, process 102 may be implemented as follows.

In the case that the distance between the terminal and the serving cell reference point does not meet the third criterion, the measurement of neighbor cells is initiated, wherein the third criterion is a terminal position-based s-measure criterion.

In some embodiments, in the case that the third criterion corresponds to a third threshold, and the distance between the terminal and the serving cell reference point is less than or equal to the third threshold, it is determined that the distance between the terminal and the serving cell reference point meets the third criterion.

The third threshold is the distance threshold corresponding to the third criterion and is represented by D_threshold1.

In some embodiments, for intra-frequency neighbor cells and inter-frequency neighbor cells, different neighbor cells correspond to separate third thresholds. The third threshold corresponding to intra-frequency neighbor cells is the same as or different from the third threshold corresponding to inter-frequency neighbor cells.

The description related to the terminal meeting the third criterion is similar to the terminal meeting the first criterion, reference may be made accordingly.

It should be understood that in all cases other than the one where the distance between the terminal and the serving cell reference point is less than or equal to the third threshold, it is considered that the distance between the terminal and the serving cell reference point does not meet the third criterion. For example, in the case that the distance between the terminal and the serving cell reference point is greater than the third threshold, it is determined that the distance between the terminal and the serving cell reference point does not meet the third criterion.

In some embodiments, during the process of initiating the measurement of neighbor cells, the following condition should be met: the terminal does not meet the s-measure criterion.

The s-measure criterion includes the third criterion and/or the fourth criterion, wherein the fourth criterion is the channel quality-based s-measure criterion. For example, the fourth criterion is the s-measure criterion based on RSRP or reference signal received quality (RSRQ).

In summary, the embodiments of the present disclosure provide a method for neighbor cell measurement in an NTN, in the method, the terminal is capable of determining whether to initiate the measurement of neighbor cells based on whether the distance and/or the distance variation between the terminal and the serving cell reference point meets the terminal position-based evaluation criterion. Depending on the different terminal position-based evaluation criteria, the corresponding neighbor cell measurement initiation conditions also differ. The terminal may initiate the measurement of neighbor cells in the case that the neighbor cell measurement initiation condition is met, which is beneficial to the reselection of the serving cell by the terminal upon trigger of the RLF, such that the mobility management requirements of the terminal is met.

FIG. 5 illustrates a flowchart of a method for neighbor cell measurement in an NTN according to some exemplary embodiments of the present disclosure. The method includes the following processes.

In process 201, a network device configures the terminal position-based evaluation criterion for a terminal.

Illustratively, the terminal position-based evaluation criterion is configured for the terminal to determine whether to initiate the measurement of neighbor cells based on whether the distance and/or the distance variation between the terminal and the serving cell reference point meets the terminal position-based evaluation criterion.

The terminal position-based evaluation criterion may be the terminal position-based mobility state evaluation criterion or the terminal position-based s-measure criterion.

In the case of configuring the terminal position-based evaluation criterion, the network device configures the evaluation duration and/or the threshold corresponding to the evaluation criterion for the terminal to facilitate the determination of the terminal.

In process 202, the terminal initiates the measurement of neighbor cells based on whether the distance and/or the distance variation between the terminal and the serving cell reference point meets the terminal position-based evaluation criterion.

The distance and/or the distance variation between the terminal and the serving cell reference point may be determined according to a distance reference value. The distance reference value may be configured by the network device for the terminal or autonomously determined by the terminal.

In some embodiments, in NB-IoT, the serving cell reference point is the reference point corresponding to the anchor carrier.

It should be understood that process 202 is the same as process 102, and reference may be made without further description herein.

Illustratively, in the multiple embodiments provided above, the processes on the terminal side may independently constitute embodiments of the method for neighbor cell measurement in an NTN applicable to the terminal, and the processes on the network device side may independently constitute embodiments of the method for neighbor cell measurement in an NTN applicable to the network device. For the specific explanations of the processes of the method for neighbor cell measurement in an NTN, reference may be made to the above content and details are not described herein any further.

In summary, the embodiments of the present disclosure provide a method for neighbor cell measurement in an NTN. Based on judgment of whether the distance and/or the distance variation between the terminal and the serving cell reference point meets the terminal position-based evaluation criterion, the terminal is capable of determining whether to initiate the measurement of neighbor cells based on the judgment result, such that the mobility management requirements of the terminal is met.

Based on FIG. 4, FIG. 6 illustrates a flowchart of a method for neighbor cell measurement in an NTN according to some exemplary embodiments of the present disclosure. Process 102 may be implemented as process 1021, which is as follows.

In process 1021, the measurement of neighbor cells is initiated in the case that the neighbor cell measurement initiation condition is met.

The neighbor cell measurement initiation condition includes at least the following item: the distance variation between the terminal and the serving cell reference point does not meet the first criterion, wherein the first criterion is a terminal position-based mobility state evaluation criterion.

In some embodiments, in NB-IoT, the serving cell reference point is the reference point corresponding to the anchor carrier.

Illustratively, the distance variation between the terminal and the serving cell reference point indicates the variation value of the distance between the position of the terminal and the position of the serving cell reference point. The distance variation includes at least one of: distance increase variation; or distance decrease variation.

The distance variation is not an absolute value, and the value of the distance variation may be positive or negative. In the case that the terminal is gradually moving away from the serving cell reference point, the value of the distance variation is positive. In the case that the terminal is gradually moving closer to the serving cell reference point, the value of the distance variation is negative.

In some embodiments, the distance variation is determined based on the distance reference value. The distance reference value is configured by the network device for the terminal or autonomously determined by the terminal, and the distance reference value is represented by Dref. The distance between the terminal and the serving cell reference point is defined as D, and the distance variation between the terminal and the serving cell reference point is represented by D-Dref.

Illustratively, the distance increase variation refers to the increase variation of the distance between the terminal and the serving cell reference point relative to the distance reference value. That is, in the case that the terminal is gradually moving away from the serving cell reference point, the value of D-Dref is positive. The distance decrease variation refers to the decrease variation of the distance between the terminal and the serving cell reference point relative to the distance reference value. That is, in the case that the terminal is gradually moving closer to the serving cell reference point, the value of D-Dref is negative.

In some embodiments, in the case that the first criterion corresponds to the first evaluation duration and the first threshold, and the distance variation between the terminal and the serving cell reference point is less than or equal to the first threshold within the first evaluation duration, it is determined that the distance variation meets the first criterion.

The first evaluation duration is represented by t-MeasureDeltaD. The first threshold is the distance variation threshold corresponding to the first criterion, and is represented by s-MeasureDeltaD.

Based on the above content, the distance variation includes at least one of: distance increase variation; or distance decrease variation. Accordingly, the distance variation meeting the first criterion includes at least one of the following two situations: the distance increase variation meets the first criterion; or the distance decrease variation meets the first criterion. That is, in the case that the increase or decrease variation of the distance between the terminal and the serving cell reference point relative to the distance reference value is less than or equal to the first threshold within the first evaluation duration, it is determined that the distance variation meets the first criterion.

The distance between the terminal and the serving cell reference point is defined as D, the distance reference value is represented by Dref, and the first threshold is represented by s-MeasureDeltaD.

In the case that the terminal is gradually moving away from the serving cell reference point, the value of D−Dref is positive. In this case, if D−Dref<=s-MeasureDeltaD is met, it is considered that the distance variation meets the first criterion; otherwise, it is considered that the distance variation does not meet the first criterion. Similarly, in the case that the terminal is gradually moving closer to the serving cell reference point, the value of D−Dref is negative. If D−Dref<=s-MeasureDeltaD is met, it is considered that the distance variation meets the first criterion.

It should be understood that, except for the above conditions that meet the first criterion, any other situation is considered as the distance variation not meeting the first criterion. For example, in the case that the first timer corresponding to the first criterion is running, it is determined that the distance variation does not meet the first criterion. For another example, in the case that the first timer corresponding to the first criterion is running and the distance variation between the terminal and the serving cell reference point is greater than the first threshold, it is determined that the distance variation does not meet the first criterion.

Illustratively, the neighbor cell measurement initiation condition may include multiple conditions. Apart from the above condition where the distance variation between the terminal and the serving cell reference point does not meet the first criterion, the neighbor cell measurement initiation condition further includes other conditions based on different criteria.

Using a scenario where the second criterion is a channel quality-based mobility state evaluation criterion as an example, for example, the second criterion is the mobility state evaluation criterion based on (N)RSRP. In the case that the network device configures both the first criterion and the second criterion for the terminal, the first timer corresponding to the first criterion may be the same as or different from the second timer corresponding to the second criterion. Depending on whether the first timer is the same as or different from the second timer, the other conditions included in the neighbor cell measurement initiation condition also differ.

In some embodiments, the neighbor cell measurement initiation condition further includes at least one of the following items: the first timer corresponding to the first criterion is running, and the terminal meets the measurement initiation condition corresponding to the s-measure criterion; the second timer corresponding to the second criterion is running, and the terminal meets the measurement initiation condition corresponding to the s-measure criterion; or the first timer corresponding to the first criterion is running, the second timer corresponding to the second criterion is running, and the terminal meets the measurement initiation condition corresponding to the s-measure criterion. The first timer corresponding to the first criterion is represented by T3XY, the second timer corresponding to the second criterion is represented by T3AB, and the first timer is different from the second timer.

In some embodiments, the neighbor cell measurement initiation condition further includes the following items: the second timer corresponding to the second criterion is running, and the terminal meets the measurement initiation condition corresponding to the s-measure criterion. The first timer is the same as the second timer, and the first criterion and the second criterion jointly use the T3AB timer.

In summary, the embodiments of the present disclosure provide a method for neighbor cell measurement in an NTN. In the case that the neighbor cell measurement initiation condition is met, the terminal may initiate the measurement of neighbor cells. The neighbor cell measurement initiation condition includes at least the following item: the distance variation between the terminal and the serving cell reference point does not meet the first criterion. Based on the method for neighbor cell measurement in an NTN according to the embodiments of the present disclosure, the terminal is capable of determining whether to initiate the measurement of neighbor cells based on the distance variation between the terminal and the serving cell reference point.

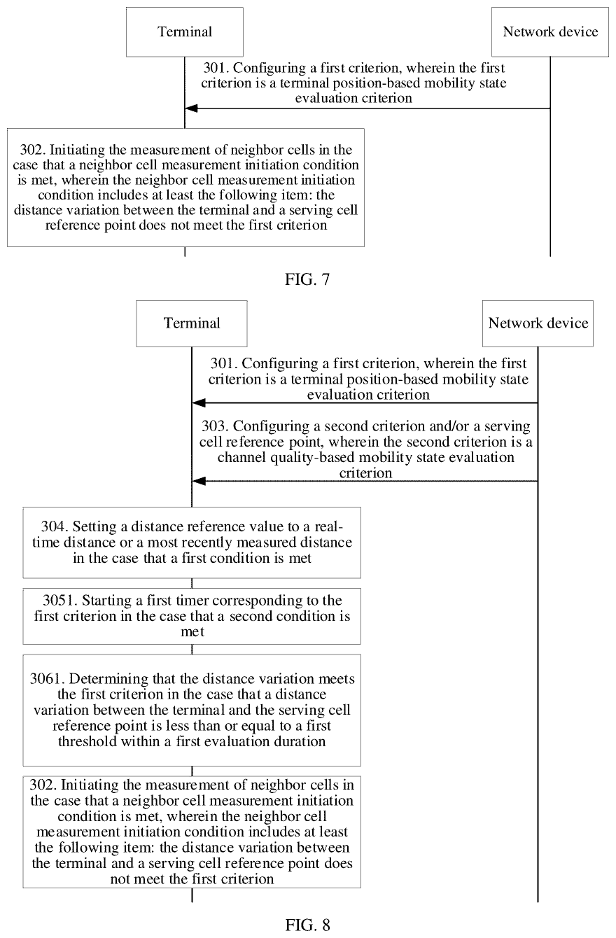

FIG. 7 illustrates a flowchart of a method for neighbor cell measurement in an NTN according to some exemplary embodiments of the present disclosure. The method includes the following processes.

In process 301, a network device configures the first criterion for a terminal.

The first criterion is the terminal position-based mobility state evaluation criterion.

In some embodiments, in the case that the first timer corresponding to the first criterion is different from the second timer corresponding to the second criterion, the first criterion includes: a first evaluation duration and a first threshold.

The first evaluation duration is determined in one of the following manners: the network device configures the first evaluation duration for the terminal; and the terminal determines the first evaluation duration based on the second evaluation duration, wherein the second evaluation duration is the evaluation duration corresponding to the second criterion.

For example, the network device explicitly configures the first evaluation duration for the terminal, wherein the first evaluation duration and the second evaluation duration are two independent configuration parameters. For another example, the terminal determines the first evaluation duration based on the second evaluation duration, such as the terminal determining the parameter value of the second evaluation duration as the parameter value of the first evaluation duration.

In some embodiments, the duration of the first timer is the first evaluation duration.

In some embodiments, in the case that the first timer corresponding to the first criterion is the same as the second timer corresponding to the second criterion, the first criterion includes: a first threshold. Since the first criterion and the second criterion share one timer, the first evaluation duration corresponding to the first criterion is the same as the second duration corresponding to the second criterion.

Illustratively, the first evaluation duration may be represented by t-MeasureDeltaD, and the first threshold may be represented by s-MeasureDeltaD; the second evaluation duration may be represented by t-MeasureDeltaP, and the second threshold may be represented by s-MeasureDeltaP.

In process 302, the terminal initiates the measurement of neighbor cells in the case that the neighbor cell measurement initiation condition is met.

The neighbor cell measurement initiation condition includes at least the following item: the distance variation between the terminal and the serving cell reference point does not meet the first criterion, wherein the first criterion is a terminal position-based mobility state evaluation criterion.

For the related descriptions of the neighbor cell measurement initiation condition, the distance variation, and the first criterion, reference may be made to the above content and is not described herein any further.

It should be understood that process 302 is the same as process 1021 and reference may be made without further description.

Illustratively, in the multiple embodiments provided above, the processes on the terminal side may independently constitute embodiments of the method for neighbor cell measurement in an NTN applicable to the terminal, and the processes on the network device side may independently constitute embodiments of the method for neighbor cell measurement in an NTN applicable to the network device. For the specific explanations of the processes of the method for neighbor cell measurement in an NTN, reference may be made to the above content and details are not described herein any further.

In summary, the embodiments of the present disclosure provide a method for neighbor cell measurement in an NTN. In the case that the neighbor cell measurement initiation condition is met, the terminal may initiate the measurement of neighbor cells. The neighbor cell measurement initiation condition includes at least the following item: the distance variation between the terminal and the serving cell reference point does not meet the first criterion. Based on the method for neighbor cell measurement in an NTN according to the embodiments of the present disclosure, the terminal is capable of determining whether to initiate the measurement of neighbor cells based on the distance variation between the terminal and the serving cell reference point.

Based on the above content, in the case of determining whether to initiate the measurement of neighbor cells based on the distance variation between the terminal and the serving cell reference point, the other conditions included in the neighbor cell measurement initiation condition differ depending on whether the first timer corresponding to the first criterion is the same as or different from the second timer corresponding to the second criterion. Below are two modes for implementing the method for neighbor cell measurement in an NTN.

1. The first timer corresponding to the first criterion is different from the second timer corresponding to the second criterion.

Illustratively, the neighbor cell measurement initiation condition further includes at least one of the following conditions.
Condition 1: The first timer corresponding to the first criterion is running, and the terminal meets the measurement initiation condition corresponding to the s-measure criterion.
Condition 2: The second timer corresponding to the second criterion is running, and the terminal meets the measurement initiation condition corresponding to the s-measure criterion.
Condition 3: The first timer corresponding to the first criterion is running, the second timer corresponding to the second criterion is running, and the terminal meets the measurement initiation condition corresponding to the s-measure criterion.

The first timer corresponding to the first criterion is represented by T3XY, the second timer corresponding to the second criterion is represented by T3AB, and the first timer is different from the second timer.

In the case that the distance variation between the terminal and the serving cell reference point does not meet the first criterion, the terminal adopts at least one of condition 1, condition 2, and condition 3.

In some embodiments, the neighbor cell measurement initiation condition adopted by the terminal is configured by the network device. For example, in the case that the network device configures the first criterion for the terminal, the network device instructs the terminal to adopt condition 1. For another example, in the case that the network device configures the second criterion for the terminal, the network device instructs the terminal to adopt condition 2.

In some embodiments, in the case that the network device configures both the first criterion and the second criterion for the terminal, the neighbor cell measurement initiation condition adopted by the terminal is determined by the network device through explicit indication information.

In some embodiments, the explicit indication information is carried in the system broadcast message.

In the case that the network device configures both the first criterion and the second criterion for the terminal, the network device may further determine the neighbor cell measurement initiation condition to be adopted for the terminal through explicit indication information. For example, the network device carries explicit indication information over the system broadcast message to instruct the terminal to adopt condition 3.

Based on FIG. 7, FIG. 8 illustrates a flowchart of a method for neighbor cell measurement in an NTN according to some exemplary embodiments of the present disclosure. The method further includes the following processes.

In process 303, the network device configures the second criterion and/or the serving cell reference point for the terminal.

Illustratively, the second criterion is the channel quality-based mobility state evaluation criterion.

In some embodiments, the second criterion includes at least one of: a second threshold; or a second evaluation duration.

The second threshold is the channel quality variation threshold corresponding to the second criterion, and is represented by s-MeasureDeltaP; the second evaluation duration is represented by t-MeasureDeltaP.

For example, the second criterion is the mobility state evaluation criterion based on (N)RSRP, and the second threshold is the (N)RSRP variation threshold.

In process 304, the terminal sets the distance reference value to the real-time distance or the most recently measured distance in the case that the first condition is met.

The distance reference value is used to determine the distance variation between the terminal and the serving cell reference point, and may be represented by Dref. The real-time distance is the distance between the real-time position of the terminal and the serving cell reference point. The most recently measured distance is the distance between the most recently acquired effective terminal position of the terminal and the serving cell reference point.

In some embodiments, the first condition includes at least one of the following items:
the network device has configured the first criterion for the terminal, and the terminal transitions from the radio resource control (RRC) non-connected state to the RRC connected state; or
the network device has configured the first criterion for the terminal, and the terminal starts the timer for monitoring/triggering an RLF.

The RRC non-connected state includes both the RRC idle state and the RRC inactive state. The timer for monitoring/triggering the RLF is the T310 timer.

Illustratively, according to process 304, the initialization of the distance reference value may be achieved. In the case that the real-time position of terminal exists and the first condition is met, the terminal may determine the real-time distance as the initialization value of the distance reference value. In the case that the most recently acquired effective terminal position of terminal exists and the first condition is met, the terminal may determine the most recently measured distance as the initialization value of the distance reference value.

In some embodiments, based on the above content, process 304 is not performed, and the network device configures the distance reference value for the terminal.

In process 3051, the terminal starts the first timer corresponding to the first criterion in the case that the second condition is met.

The first timer is configured to evaluate the mobility state of the terminal.

In some embodiments, the second condition includes at least one of the following items:
the network device has configured the first criterion for the terminal, and the terminal transitions from the RRC non-connected state to the RRC connected state;
the network device has configured the first criterion for the terminal, the terminal transitions from the RRC non-connected state to the RRC connected state, and the terminal in the RRC non-connected state does not meet the neighbor cell measurement relaxation criterion; or
the network device has configured the first criterion for the terminal, and the terminal starts the timer for monitoring/triggering an RLF.

The timer for monitoring/triggering the RLF is the T310 timer.

In some embodiments, the duration of the first timer is the first evaluation duration corresponding to the first criterion.

According to process 304, the initialization of the distance reference value may be achieved. According to process 3051, the first timer corresponding to the first criterion may be started. Subsequently, when the terminal moves, it is necessary to update the distance reference value and start/restart the first timer.

In some embodiments, the method for neighbor cell measurement in an NTN according to the embodiments of the present disclosure further includes the following processes:
in the case that the variation of the real-time distance is greater than or equal to the first threshold corresponding to the first criterion, the distance reference value is updated to a changed real-time distance, and the first timer corresponding to the first criterion is started or restarted; or
in the case that the variation of the most recently measured distance is greater than or equal to the first threshold, the distance reference value is updated to a changed most recently measured distance, and the first timer corresponding to the first criterion is started or restarted.

The distance reference value is used to determine the distance variation between the terminal and the serving cell reference point, the real-time distance is the distance between the real-time position of terminal and the serving cell reference point, and the most recently measured distance is the distance between the most recently acquired effective terminal position of terminal and the serving cell reference point.

When the terminal moves, the real-time position of terminal or the most recently acquired effective terminal position will change, thus leading to changes in the real-time distance and the most recently measured distance. Based on this, upon move of the terminal, in the case of meeting the conditions given above, the terminal needs to update the distance reference value and start/restart the first timer.

Based on the above content, the real-time distance or the most recently measured distance is defined as D, the distance reference value is represented by Dref, the first threshold is represented by s-MeasureDeltaD, and the first timer is represented by T3XY, then:
in the case that (D−Dref)>s-MeasureDeltaD is met, the terminal sets Dref=D and simultaneously starts or restarts T3XY.

In process 3061, the terminal determines that the distance variation meets the first criterion in the case that the distance variation between the terminal and the serving cell reference point is less than or equal to the first threshold within the first evaluation duration.

The first criterion corresponds to the first evaluation duration and the first threshold. For the related descriptions of the first evaluation duration, the first threshold, and the distance variation, reference may be made to the above content, which is not described herein any further.

In some embodiments, the duration of the first timer corresponding to the first criterion is the first evaluation duration.

In some embodiments, the serving cell reference point refers to the reference point corresponding to the anchor carrier.

Based on the above content, the distance variation meets the first criterion under the following condition: the distance variation between the terminal and the serving cell reference point is less than or equal to the first threshold within the first evaluation duration. The “within the first evaluation duration” may be implemented as the first timer corresponding to the first criterion is running.

It should be understood that, except for the above condition, any other situation are considered as the distance variation not meeting the first criterion. For example, in the case that the first timer corresponding to the first criterion is running, it is determined that the distance variation does not meet the first criterion. For another example, in the case that the first timer corresponding to the first criterion is running and the distance variation between the terminal and the serving cell reference point is greater than the first threshold, it is determined that the distance variation does not meet the first criterion.

The real-time distance or the most recently measured distance is defined as D, the distance reference value is represented by Dref, the first threshold is represented by s-MeasureDeltaD, and the first evaluation duration is represented by t-MeasureDeltaD, then:
in the case that (D−Dref)<=s-MeasureDeltaD within t-MeasureDeltaD, the terminal meets the first criterion;
otherwise, it is considered that the terminal does not meet the first criterion.

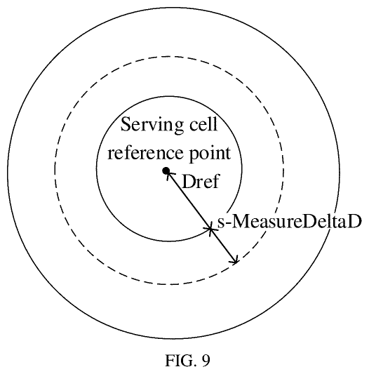

FIG. 9 illustrates a schematic diagram of performing the measurement of neighbor cells according to some exemplary embodiments of the present disclosure. The outer solid circle indicates the coverage area of the serving cell where the terminal is located, the inner solid circle indicates that the distance between the terminal and the serving cell reference point reaches the distance reference value, and the dashed circle indicates the first threshold.

The real-time distance or the most recently measured distance is defined as D, the distance reference value is represented by Dref, and the first threshold is represented by s-MeasureDeltaD. Assuming that the terminal is within the inner solid circle, then the terminal moves in a direction away from the serving cell reference point, causing the value of D to change.

Assuming that within the first evaluation duration, in the case that the terminal moves to the area between the inner solid circle and the dashed circle, there is a distance variation, and the value of the distance variation is D−Dref. In this case, if the distance variation between the terminal and the serving cell reference point is less than or equal to the first threshold, it is determined that the distance variation meets the first criterion.

Subsequently, the terminal continues to move in a direction away from the serving cell reference point. In the case that the terminal moves to the area between the dashed circle and the outer solid circle, there will be (D−Dref)>s-MeasureDeltaD, and the condition for the distance variation to meet the first criterion is no longer met. In this case, it is determined that the distance variation does not meet the first criterion, and the terminal initiates the measurement of neighbor cells.

Meanwhile, in the case of (D−Dref)>s-MeasureDeltaD, the terminal may update the value of Dref and simultaneously start or restart the first timer corresponding to the first criterion.

Based on the above content, in the case that the first timer corresponding to the first criterion is different from the second timer corresponding to the second criterion, in addition to the distance variation between the terminal and the serving cell reference point not meeting the first criterion, the neighbor cell measurement initiation condition further includes at least one of the following conditions.
Condition 1: The first timer corresponding to the first criterion is running, and the terminal meets the measurement initiation condition corresponding to the s-measure criterion.
Condition 2: The second timer corresponding to the second criterion is running, and the terminal meets the measurement initiation condition corresponding to the s-measure criterion.
Condition 3: The first timer corresponding to the first criterion is running, the second timer corresponding to the second criterion is running, and the terminal meets the measurement initiation condition corresponding to the s-measure criterion.

Using a scenario where the first timer corresponding to the first criterion is represented by T3XY and the second timer corresponding to the second criterion is represented by T3AB as an example, it should be understood that, combining the multiple conditions provided above, the terminal initiates the measurement of neighbor cells under at least one of the following conditions:
the terminal only needs to not meet the first criterion, T3XY is running, and the terminal meets the measurement initiation condition corresponding to the s-measure criterion;
the terminal does not meet the first criterion or does not meet the second criterion, T3AB is running or T3XY is running, and the terminal meets the measurement initiation condition corresponding to the s-measure criterion; or
the terminal does not meet both the first criterion and the second criterion simultaneously, T3AB is running and T3XY is running, and the terminal meets the measurement initiation condition corresponding to the s-measure criterion.

In some embodiments, the neighbor cell measurement initiation condition adopted by the terminal is configured by the network device. In some embodiments, in the case that the network device configures both the first criterion and the second criterion for the terminal, the neighbor cell measurement initiation condition adopted by the terminal is determined by the network device through explicit indication information. The explicit indication information is carried in the system broadcast message.

In some embodiments, in the case that the first timer corresponding to the first criterion is different from and the second timer corresponding to the second criterion, the method for neighbor cell measurement in an NTN according to the embodiments of the present disclosure further includes the following processes.

In the case of no real-time distance and no most recently measured distance, whether to initiate the measurement of neighbor cells is determined by falling back to using the second criterion.

The real-time distance is the distance between the real-time position of terminal and the serving cell reference point, and the most recently measured distance is the distance between the most recently acquired effective terminal position of terminal and the serving cell reference point.

Based on the above content, in the case of no real-time distance and no most recently measured distance, the terminal is unable to determine the distance variation between the terminal and the serving cell reference point, which makes it impossible for the terminal to determine whether the first criterion is met. In this case, the terminal can fall back to using the second criterion for determination. For example, in this case, the terminal determines whether to initiate the measurement of neighbor cells by falling back to using the RSRP-based mobility state evaluation criterion.

Illustratively, in the multiple embodiments provided above, the processes on the terminal side may independently constitute embodiments of the method for neighbor cell measurement in an NTN applicable to the terminal, and the processes on the network device side may independently constitute embodiments of the method for neighbor cell measurement in an NTN applicable to the network device. For the specific explanations of the processes of the method for neighbor cell measurement in an NTN, reference may be made to the above content and details are not described herein any further.

In summary, the embodiments of the present disclosure provide a method for neighbor cell measurement in an NTN. In the case that the first timer corresponding to the first criterion is different from the second timer corresponding to the second criterion, the corresponding neighbor cell measurement initiation conditions are given.

In some embodiments, the embodiments of the present disclosure further provide the contents related to the initialization setting of the distance reference value, the start of the first timer, the update of the distance reference value, and the restart of the first timer, such that the terminal can determine whether the first criterion is met based on the distance reference value and the first timer.

In some embodiments, the embodiments of the present disclosure further provide the conditions for meeting the first criterion. It should be understood that, except for meeting the first condition given above, all other situations are considered as not meeting the first criterion.

2. The first timer corresponding to the first criterion is the same as the second timer corresponding to the second criterion.

Illustratively, the neighbor cell measurement initiation condition further includes the following items: the second timer corresponding to the second criterion is running, and the terminal meets the measurement initiation condition corresponding to the s-measure criterion.

The second criterion is the channel quality-based mobility state evaluation criterion, the second timer corresponding to the second criterion may be represented by T3AB, and the first timer is the same as the second timer.

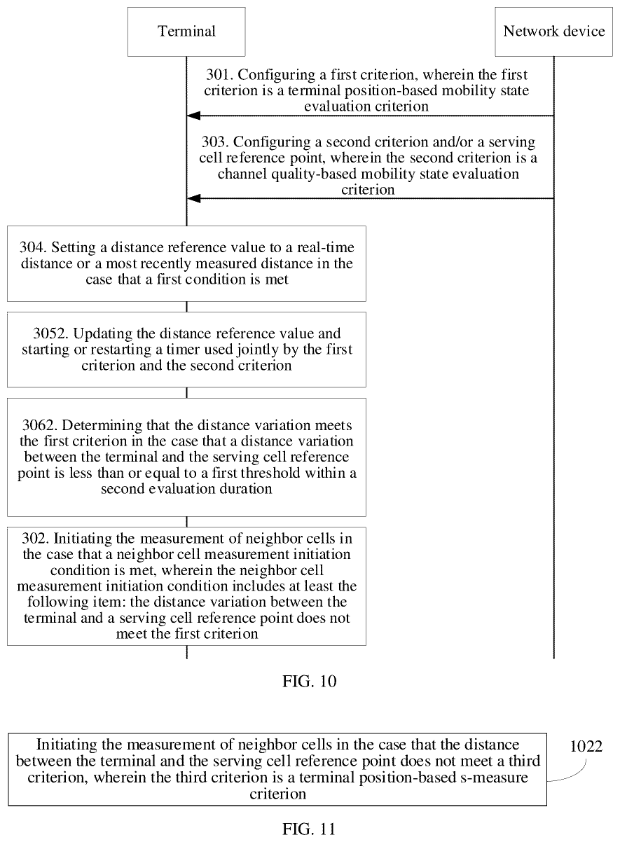

Based on FIG. 7, FIG. 10 illustrates a flowchart of a method for neighbor cell measurement in an NTN according to some exemplary embodiments of the present disclosure. The method further includes the following processes.

In process 303, the network device configures the second criterion and/or the serving cell reference point for the terminal.

Illustratively, the second criterion is the channel quality-based mobility state evaluation criterion.

In some embodiments, the second criterion includes at least one of: a second threshold; or a second evaluation duration.

The second threshold is the channel quality variation threshold corresponding to the second criterion, and is represented by s-MeasureDeltaP. The second evaluation duration is represented by t-MeasureDeltaP.

For example, the second criterion is (N)RSRP-based mobility state evaluation criterion, and the second threshold is the (N)RSRP variation threshold.

In process 304, the terminal sets the distance reference value to the real-time distance or the most recently measured distance in the case that the first condition is met.

The distance reference value is used to determine the distance variation between the terminal and the serving cell reference point, and may be represented by Dref; the real-time distance is the distance between the real-time position of terminal and the serving cell reference point, and the most recently measured distance is the distance between the most recently acquired effective terminal position of terminal and the serving cell reference point.

In some embodiments, the first condition includes at least one of the following items;
the network device has configured the first criterion for the terminal, and the terminal transitions from the RRC non-connected state to the RRC connected state; or
the network device has configured the first criterion for the terminal, and the terminal starts the timer for monitoring/triggering an RLF.

The timer for monitoring/triggering RLF is the T310 timer.

Illustratively, according to process 304, the initialization of the distance reference value may be achieved. In the case that the real-time position of terminal exists and the first condition is met, the terminal may determine the real-time distance as the initialization value of the distance reference value. In the case that the most recently acquired effective terminal position of terminal exists and the first condition is met, the terminal may determine the most recently measured distance as the initialization value of the distance reference value.

In some embodiments, based on the above content, process 304 is not performed, and the network device configures the distance reference value for the terminal.

In process 3052, the terminal updates the distance reference value and starts or restarts the timer used jointly by the first criterion and the second criterion.

Illustratively, executing process 3052 needs to be carried out in one of the following situations:
in the case that the third condition is met, the distance reference value is updated to the real-time distance or the most recently measured distance, and the timer used jointly by the first criterion and the second criterion is started or restarted;
in the case that the variation of the real-time distance is greater than or equal to the first threshold corresponding to the first criterion, the distance reference value is updated to a changed real-time distance, and the timer used jointly by the first criterion and the second criterion is started or restarted;
in the case that the variation of the most recently measured distance is greater than or equal to the first threshold, the distance reference value is updated to a changed most recently measured distance, and the timer used jointly by the first criterion and the second criterion is started or restarted;
in the case that the third condition is met and the variation of the real-time distance is greater than or equal to the first threshold corresponding to the first criterion, the distance reference value is updated to a changed real-time distance, and the timer used jointly by the first criterion and the second criterion is started or restarted;
in the case that the third condition is met and the variation of the most recently measured distance is greater than or equal to the first threshold, the distance reference value is updated to a changed most recently measured distance, and the timer used jointly by the first criterion and the second criterion is started or restarted;
in the case that the third condition is met or the variation of the real-time distance is greater than or equal to the first threshold corresponding to the first criterion, the distance reference value is updated to a changed real-time distance, and the timer used jointly by the first criterion and the second criterion is started or restarted; or
in the case that the third condition is met or the variation of the most recently measured distance is greater than or equal to the first threshold, the distance reference value is updated to a changed most recently measured distance, and the timer used jointly by the first criterion and the second criterion is started or restarted.

The distance reference value is used to determine the distance between the terminal and the serving cell reference point, the real-time distance is the distance between the real-time position of terminal and the serving cell reference point, and the most recently measured distance is the distance between the most recently acquired effective terminal position of terminal and the serving cell reference point.

In some embodiments, the third condition includes the following item: the variation of the RSRP of the terminal on the anchor carrier in the serving cell relative to the RSRP reference value is greater than the RSRP variation threshold.

Similar to the distance variation, the variation of the RSRP of the terminal on the anchor carrier in the serving cell relative to the RSRP reference value is also not an absolute value, and the value thereof may be positive or negative. Illustratively, the variation of the RSRP of the terminal on the anchor carrier in the serving cell relative to the RSRP reference value includes at least one of: RSRP increase variation; or RSRP decrease variation.

The RSRP increase variation refers to the variation of increase in the RSRP of the terminal on the anchor carrier in the serving cell relative to the RSRP reference value; and the RSRP decrease variation refers to the variation of decrease in the RSRP of the terminal on the anchor carrier in the serving cell relative to the RSRP reference value.

It should be understood that the third condition includes at least one of the following two situations: the RSRP increase variation is greater than the RSRP variation threshold; or the RSRP decrease variation is greater than the RSRP variation threshold.

The RSRP of the terminal on the anchor carrier in the serving cell is represented by RSRP-PowerOffsetNonAnchor, the RSRP reference value is represented by RSRPref, and the RSRP variation threshold is represented by s-MeasureDeltaP. Therefore, the variation of the RSRP of the terminal on the anchor carrier in the serving cell relative to the RSRP reference value may be represented by RSRPref−(RSRP-PowerOffsetNonAnchor).

In some embodiments, the method for neighbor cell measurement in an NTN provided in the embodiments of the present disclosure further includes: updating the RSRP reference value in the case of restarting the timer used jointly by the first criterion and the second criterion.

Based on the above content, the real-time distance or the most recently measured distance id defined as D, the distance reference value is represented by Dref, the first threshold is represented by s-MeasureDeltaD, and the timer used jointly by the first criterion and the second criterion is represented by T3AB, then:
in the case that RSRPref−(RSRP-PowerOffsetNonAnchor)>s-MeasureDeltaP is met, the terminal sets Dref=D, simultaneously starts or restarts T3AB, and updates RSRPref;
in the case that (D−Dref)>s-MeasureDeltaD is met, the terminal sets Dref=D, simultaneously starts or restarts T3AB, and updates RSRPref;
in the case that RSRPref−(RSRP-PowerOffsetNonAnchor)>s-MeasureDeltaP and (D−Dref)>s-MeasureDeltaD are both met, the terminal sets Dref=D, simultaneously starts or restarts T3AB, and updates RSRPref; or
in the case that RSRPref−(RSRP-PowerOffsetNonAnchor)>s-MeasureDeltaP or (D−Dref)>s-MeasureDeltaD is met, the terminal sets Dref=D, simultaneously starts or restarts T3AB, and updates RSRPref.

The RSRPref indicates the RSRP reference value, the RSRP-PowerOffsetNonAnchor indicates the RSRP of the terminal on the anchor carrier in the serving cell, and the s-MeasureDeltaP indicates the RSRP variation threshold.

In process 3062, it is determined that the distance variation meets the first criterion in the case that the distance variation between the terminal and the serving cell reference point is less than or equal to the first threshold within the second evaluation duration.

Illustratively, the distance variation is determined based on the distance reference value, and the second evaluation duration is the evaluation duration corresponding to the second criterion. For the related descriptions of the distance variation and the distance reference value, reference may be made to the above content, which is not described herein any further.

In some embodiments, the duration of the timer used jointly by the first criterion and the second criterion is the second evaluation duration. For the related descriptions of the second evaluation duration, the first threshold, and the distance variation, reference may be made to the above content, which is not described herein any further.

In some embodiments, the serving cell reference point refers to the reference point corresponding to the anchor carrier.

Based on the above content, the distance variation meets the first criterion under the following condition: the distance variation between the terminal and the serving cell reference point is less than or equal to the first threshold within the second evaluation duration. The “within the second evaluation duration” may be implemented as the timer used jointly by the first criterion and the second criterion is running.

It should be understood that, except for the above condition, any other situation is considered as the distance variation not meeting the first criterion. For example, in the case that the timer used jointly by the first criterion and the second criterion is running, it is determined that the distance variation does not meet the first criterion. For another example, in the case that the timer used jointly by the first criterion and the second criterion is running and the distance variation between the terminal and the serving cell reference point is greater than the first threshold, it is determined that the distance variation does not meet the first criterion.

It should be understood that process 3061 is similar to process 3062 and reference may be made without further description.

Illustratively, in the multiple embodiments provided above, the processes on the terminal side may independently constitute embodiments of the method for neighbor cell measurement in an NTN applicable to the terminal, and the processes on the network device side may independently constitute embodiments of the method for neighbor cell measurement in an NTN applicable to the network device. For the specific explanations of the processes of the method for neighbor cell measurement in an NTN, reference may be made to the above content and details are not described herein any further.

In summary, the embodiments of the present disclosure provide a method for neighbor cell measurement in an NTN. In the case that the first timer corresponding to the first criterion is the same as the second timer corresponding to the second criterion, the corresponding neighbor cell measurement initiation conditions are given.

In some embodiments, the embodiments of the present disclosure further provide the contents related to the initialization setting of the distance reference value, the update of the distance reference value, and the start/restart of the timer jointly used by the first criterion and the second criterion, such that the terminal is capable of determining whether the first criterion is met based on the distance reference value and the timer jointly used by the first criterion and the second criterion.

In some embodiments, the embodiments of the present disclosure further provide the conditions for meeting the first criterion. It should be understood that, except for meeting the first condition given above, all other situations are considered as not meeting the first criterion.

Based on the above content, the terminal may also determine whether to initiate the measurement of neighbor cells based on the distance between the terminal and the serving cell reference point.

Based on FIG. 4, FIG. 11 illustrates a flowchart of a method for neighbor cell measurement in an NTN according to some exemplary embodiments of the present disclosure. Process 102 may be implemented as process 1022, which is as follows.

In process 1022, the measurement of neighbor cells is initiated in the case that the distance between the terminal and the serving cell reference point does not meet the third criterion.

Illustratively, the third criterion is the terminal position-based s-measure criterion.

In some embodiments, in NB-IoT, the serving cell reference point is the reference point corresponding to the anchor carrier.

The distance between the terminal and the serving cell reference point may be determined based on the real-time distance or the most recently measured distance. The real-time distance is the distance between the real-time position of terminal and the serving cell reference point, and the most recently measured distance is the distance between the most recently acquired effective terminal position of terminal and the serving cell reference point. In the case that the real-time position of terminal exists, the distance between the terminal and the serving cell reference point is determined as the value of the real-time distance; and in the case that the most recently acquired effective terminal position of terminal exists, the distance between the terminal and the serving cell reference point is determined as the most recently measured distance.

In some embodiments, in the case that the third criterion corresponds to a third threshold, the terminal determines whether the third criterion is met based on the following condition: in the case that the distance between the terminal and the serving cell reference point is less than or equal to the third threshold, it is determined that the terminal meets the third criterion.

The third threshold is the distance threshold corresponding to the third criterion and is represented by D_threshold1.

Different neighbor cells have different third thresholds. In some embodiments, intra-frequency neighbor cells and inter-frequency neighbor cells correspond to separate third thresholds.

The real-time distance or the most recently measured distance is defined as D, and the third threshold is represented by D_threshold1, then:
in the case that D<D_threshold1 or D<=D_threshold1, the terminal meets the third criterion;
otherwise, it is considered that the terminal does not meet the third criterion.

In the case that it is determined that the terminal does not meet the third criterion, the terminal initiates the measurement of neighbor cells.

In summary, the embodiments of the present disclosure provide a method for neighbor cell measurement in an NTN. The terminal may determine whether to initiate the measurement of neighbor cells based on the distance between the terminal and the serving cell reference point.

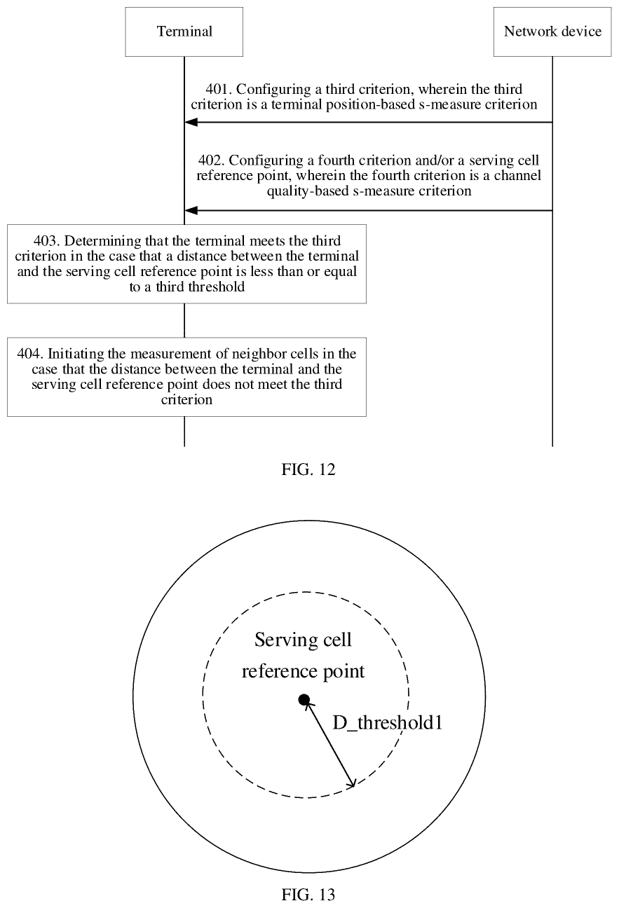

FIG. 12 illustrates a flowchart of a method for neighbor cell measurement in an NTN according to some exemplary embodiments of the present disclosure. The method includes the following processes.

In process 401, a network device configures the third criterion for a terminal.

The third criterion is the terminal position-based s-measure criterion.

In some embodiments, the third criterion includes a third threshold. For the related description of the third threshold, reference may be made to the above content.

Based on the above content, intra-frequency neighbor cells and inter-frequency neighbor cells correspond to separate third thresholds.

In some embodiments, process 401 includes: transmitting the third criterion to the terminal, wherein the third criterion includes the third threshold corresponding to intra-frequency neighbor cells and the third threshold corresponding to inter-frequency neighbor cells.

In process 402, the network device configures the fourth criterion and/or the serving cell reference point for the terminal.

The fourth criterion is the channel quality-based s-measure criterion. For example, the fourth criterion is RSRP/RSRQ-based s-measure criterion.

Illustratively, the serving cell reference point is used by the terminal to determine whether the distance or the distance variation between the terminal and the serving cell reference point meets the terminal position-based evaluation criterion.

In some embodiments, the serving cell reference point refers to the reference point corresponding to the anchor carrier.

In process 403, the terminal determines that the terminal meets the third criterion in the case that the distance between the terminal and the serving cell reference point is less than or equal to the third threshold.

In some embodiments, intra-frequency neighbor cells and inter-frequency neighbor cells correspond to separate third thresholds.

The terminal meets the third criterion under the following condition: the distance between the terminal and the serving cell reference point is less than or equal to the third threshold, wherein the third threshold is the distance threshold corresponding to the third criterion and is represented by D_threshold1.

Illustratively, the distance between the terminal and the serving cell reference point is determined based on the actual distance or the most recently measured distance. For the specific determination process, reference may be made to the above content, which is not described herein any further. The real-time distance or the most recently measured distance is defined as D, and the third threshold is represented by D_threshold1, then:
in the case that D<D_threshold1 or D<=D_threshold1, the terminal meets the third criterion;
otherwise, it is considered that the terminal does not meet the third criterion.

FIG. 13 illustrates a schematic diagram of performing the measurement of neighbor cells according to some exemplary embodiments of the present disclosure. The solid circle indicates the coverage area of the serving cell where the terminal is located, and the dashed circle indicates the third threshold corresponding to the third criterion.

In the case that the real-time distance or the most recently measured distance is defined as D, and the third threshold is represented by D_threshold1, the distance between the terminal and the serving cell reference point may also be represented by D.

Assuming that the terminal is within the dashed circle, in the case that D<D_threshold1 or D<=D_threshold1, it may be determined that the terminal meets the third criterion.

Subsequently, the terminal continues to move in a direction away from the serving cell reference point. In the case that the terminal moves to the area between the solid circle and the dashed circle, D>D_threshold1. In this case, the distance between the terminal and the serving cell reference point is greater than the third threshold, and the condition for the terminal to meet the third criterion will no longer be met.

In process 404, the terminal initiates the measurement of neighbor cells in the case that the terminal does not meet the measurement initiation condition corresponding to the s-measure criterion.

The s-measure criterion includes the third criterion and/or the fourth criterion, wherein the fourth criterion is the channel quality-based s-measure criterion.

In some embodiments, the terminal not meeting the measurement initiation condition corresponding to the s-measure criterion, includes at least one of the following items: the distance between the terminal and the serving cell reference point does not meet the third criterion; the terminal does not meet the fourth criterion; or the distance between the terminal and the serving cell reference point does not meet the third criterion, and the terminal does not meet the fourth criterion.

For the related descriptions of the third criterion and the fourth criterion, reference may be made to the above content, which is not described herein any further.

In some embodiments, the measurement initiation condition corresponding to the s-measure criterion adopted by the terminal is configured by the network device.

In some embodiments, in the case that the network device configures both the third criterion and the fourth criterion for the terminal, the measurement initiation condition corresponding to the s-measure criterion adopted by the terminal is determined by the network device through explicit indication information.

In some embodiments, the explicit indication information is carried in the system broadcast message.

It should be understood that the terminal initiates the measurement of neighbor cells under at least one of the following conditions:
the terminal does not meet the third criterion;
the terminal does not meet the third criterion or the fourth criterion; or
the terminal does not meet the third criterion and does not meet the fourth criterion.

In the case that the network device only configures the third criterion for the terminal, the network device may instruct the terminal to use the first condition to determine whether to initiate the measurement of neighbor cells. In the case that the network device only configures the fourth criterion for the terminal, the network device may instruct the terminal to use the second condition to determine whether to initiate the measurement of neighbor cells. In the case that the network device configures both the third criterion and the fourth criterion for the terminal, the network device may use the explicit indication information carried in the system broadcast message to instruct the terminal to use one of the above three conditions for determination.

In some embodiments, the method for neighbor cell measurement in an NTN according to the embodiments of the present disclosure further includes the following processes.

In the case of no real-time distance and no most recently measured distance, whether to initiate the measurement of neighbor cells is determined by falling back to using the fourth criterion.

The real-time distance is the distance between the real-time position of terminal and the serving cell reference point, and the most recently measured distance is the distance between the most recently acquired effective terminal position of terminal and the serving cell reference point.

Based on the above content, in the case of no real-time distance and no most recently measured distance, the terminal is unable to determine the distance between the terminal and the serving cell reference point, which makes it impossible for the terminal to determine whether the third criterion is met. In this case, the terminal may fall back to using the fourth criterion for determination. For example, in this case, the terminal determines whether to initiate the measurement of neighbor cells by falling back to using RSRP/RSRQ-based s-measure criterion.

Illustratively, in the multiple embodiments provided above, the processes on the terminal side may independently constitute embodiments of the method for neighbor cell measurement in an NTN applicable to the terminal, and the processes on the network device side may independently constitute embodiments of the method for neighbor cell measurement in an NTN applicable to the network device. For the specific explanations of the processes of the method for neighbor cell measurement in an NTN, reference may be made to the above content and details are not described herein any further.

In summary, the embodiments of the present disclosure provide a method for neighbor cell measurement in an NTN. The terminal may determine whether to initiate the measurement of neighbor cells based on the distance between the terminal and the serving cell reference point.

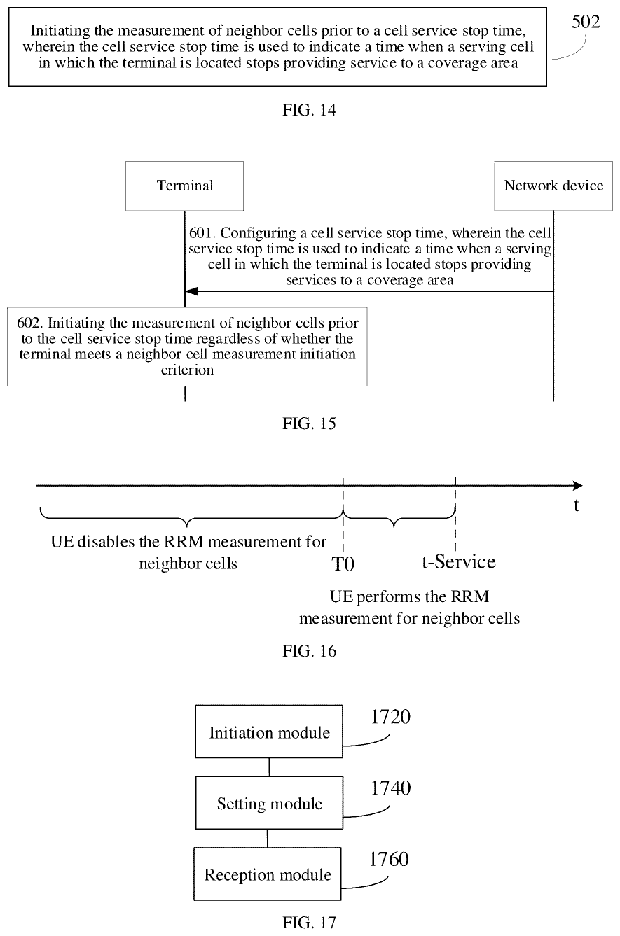

The embodiments of the present disclosure further provide a method for neighbor cell measurement in an NTN to meet the mobility management requirements of the terminal. FIG. 14 provides a flowchart of a method for neighbor cell measurement in an NTN according to some exemplary embodiments of the present disclosure. The method is applicable to a terminal and includes the following process.

In process 502, the measurement of neighbor cells is initiated prior to a cell service stop time.

Illustratively, the cell service stop time indicates the time when the serving cell in which the terminal is located stops providing services to the coverage area. The cell service stop time may be represented by t-Service.

In some embodiments, the cell service stop time is one of the following parameters:
a time parameter for the terminal in an RRC non-connected state to initiate the RRM measurement of neighbor cells; or
a dedicated time parameter for the terminal in an RRC connected state to initiate the RRC measurement of non-serving cells.

In some embodiments, the terminal reuses the existing time parameter for the terminal in an RRC non-connected state to initiate the RRM measurement of neighbor cells. In some other embodiments, considering that the measurement requirements in the RRC connected state and the RRC non-connected state may differ, the network device configures a dedicated time parameter separately for the terminal in an RRC connected state to initiate the RRC measurement of non-serving cells. The non-serving cell refers to cells other than the serving cell in which the terminal is located.

In some embodiments, the cell service stop time is transmitted over system broadcast or terminal-specific signaling.

The terminal-specific signaling includes at least one of: RRC signaling; or medium access control (MAC) control element (CE) signaling.

Based on the above content, the network device may configure the terminal for any one or more of the first criterion, the second criterion, the third criterion, or the fourth criterion to facilitate the terminal in determining whether one or more of the criteria are met. In the embodiments of the present disclosure, regardless of whether the terminal meets the above criteria, the measurement of neighbor cells is initiated prior to the cell service stop time, and hence the terminal is capable of performing cell reselection as soon as possible when an RLF occurs, such that the mobility management requirements of the terminal is met.

In summary, the embodiments of the present disclosure provide a method for neighbor cell measurement in an NTN, allowing the terminal to initiate the measurement of neighbor cells prior to the cell service stop time, thereby facilitating the terminal to complete cell reselection as soon as possible, such that the mobility management requirements of the terminal are met.

In some embodiments, the embodiments of the present disclosure further provide two optional methods for determining the cell service stop time.

FIG. 15 illustrates a flowchart of a method for neighbor cell measurement in an NTN according to some exemplary embodiments of the present disclosure. The method includes the following processes.

In process 601, a network device configures a cell service stop time for a terminal.

Illustratively, the cell service stop time indicates the time when the serving cell in which the terminal is located stops providing services to the coverage area. The cell service stop time may be represented by t-Service.

In some embodiments, the cell service stop time is one of: a time parameter for the terminal in an RRC non-connected state to initiate the RRM measurement of neighbor cells; or a dedicated time parameter for the terminal in an RRC connected state to initiate the RRC measurement of non-serving cells.

In some embodiments, the cell service stop time is transmitted over system broadcast or terminal-specific signaling.

In some embodiments, the terminal-specific signaling includes at least one of: RRC signaling; or MAC CE signaling.

In process 602, the terminal initiates the measurement of neighbor cells prior to the cell service stop time regardless of whether the terminal meets the neighbor cell measurement initiation criterion.

In some embodiments, the neighbor cell measurement initiation criterion includes at least one of: a mobility state evaluation criterion; or an s-measure criterion.

In some embodiments, the mobility state evaluation criterion includes at least one of: a first criterion, which is the terminal position-based mobility state evaluation criterion; or a second criterion, which is the channel quality-based mobility state evaluation criterion.

In some embodiments, the s-measure criterion includes at least one of: a third criterion, which is the terminal position-based s-measure criterion; or a fourth criterion, which is the channel quality-based s-measure criterion.

For the related descriptions of the first criterion, the second criterion, the third criterion, and the fourth criterion, reference may be made to the above content, which is not described herein any further.

In some embodiments, the time point at which the terminal initiates the measurement of neighbor cells is set according to actual needs, which is not limited by the present disclosure. For example, the time point at which the terminal initiates the measurement of neighbor cells is autonomously determined by the terminal.

FIG. 16 illustrates a schematic diagram of performing the measurement of neighbor cells according to some exemplary embodiments of the present disclosure. TO indicates the time point at which the terminal starts initiating the measurement of neighbor cells, and t-Service indicates the cell service stop time.

For a terminal in an RRC connected state, in the case that the network device has configured at least one of the above criteria for the terminal and the network device has configured the cell service stop time for the terminal, then regardless of whether the terminal meets any one or more of the criteria, the terminal needs to start performing the RRM measurement for neighbor cells prior to the cell service stop time. Referring to FIG. 16, before TO, the terminal disables the RRM measurement for neighbor cells. Between TO and t-Service, the terminal performs the RRM measurement for neighbor cells.

In summary, the embodiments of the present disclosure provide a method for neighbor cell measurement in an NTN. Regardless of whether the terminal meets the neighbor cell measurement initiation criterion, the terminal initiates the measurement of neighbor cells prior to the cell service stop time.

Based on the above content, the embodiments of the present disclosure provide four different methods for neighbor cell measurement in an NTN. Using a scenario where the first criterion is a terminal position-based mobility state evaluation criterion, the second criterion is the channel quality-based mobility state evaluation criterion, the third criterion is the terminal position-based s-measure criterion, and the fourth criterion is the channel quality-based s-measure criterion, the following illustrates four different modes for implementing the method for neighbor cell measurement in an NTN.

Implementation Mode 1: The Network Device Configures the First Criterion and the Second Criterion for the Terminal, and the First Timer Corresponding to the First Criterion is Different from the Second Timer Corresponding to the Second Criterion; Whether to Initiate the Measurement of Neighbor Cells is Determined Based on the Distance Variation Between the Terminal and the Serving Cell Reference Point.

The specific implementation process is as follows.

In process 11, the network device configures the neighbor cell measurement-related information regarding terminals in a connected state for the terminal.

Illustratively, the neighbor cell measurement-related information includes at least one of: a first criterion; a second criterion; or a serving cell reference point.

In some embodiments, the first criterion includes: a first threshold and a first evaluation duration; and the second criterion includes: a second threshold and a second evaluation duration.

The first threshold is the distance variation threshold corresponding to the first criterion, and is represented by s-MeasureDeltaD. The first evaluation duration is represented by t-MeasureDeltaD. The second threshold is the distance variation threshold corresponding to the second criterion, and is represented by s-MeasureDeltaP. The second evaluation duration is represented by t-MeasureDeltaP.

In some embodiments, the first evaluation duration is determined in one of the following manners:
the network device configures the first evaluation duration for the terminal; or
the terminal determines the first evaluation duration based on the second evaluation duration, wherein the second evaluation duration is the evaluation duration corresponding to the second criterion.

For example, the network device explicitly configures the first evaluation duration for the terminal, wherein the first evaluation duration and the second evaluation duration are two independent configuration parameters. For another example, the terminal determines the first evaluation duration based on the second evaluation duration, such as the terminal determining the parameter value of the second evaluation duration as the parameter value of the first evaluation duration.

In process 12, the terminal determines whether the first criterion is met based on the distance variation between the terminal and the serving cell reference point.

In some embodiments, it is considered that the terminal meets the first criterion in the case that the variation of the distance between the terminal and the serving cell reference point relative to the distance reference value is less than or equal to the first threshold within the first evaluation duration. The terminal meeting the first criterion is one of the conditions for not performing the neighbor cell measurement.

The variation of the distance between the terminal and the serving cell reference point relative to the distance reference value includes at least one of: the variation of increase in distance; or the variation of decrease in distance.

Based on the above content, the variation of increase in the distance between the terminal and the serving cell reference point relative to the distance reference value is referred to as the distance increase variation, and the variation of decrease in the distance between the terminal and the serving cell reference point relative to the distance reference value is referred to as the distance decrease variation. Accordingly, the terminal meeting the first criterion includes at least one of the following two situations: the distance increase variation meets the first criterion; or the distance decrease variation meets the first criterion.

In some embodiments, for NB-IoT, the serving cell reference point refers to the reference point corresponding to the anchor carrier.

To determine the distance variation, a distance reference value represented by Dref may be introduced. The distance reference value may be configured by the network device or autonomously determined by the terminal.

Meanwhile, the first timer corresponding to the first criterion is defined as T3XY. In some embodiments, the duration of the T3XY timer is the first evaluation duration.

The following describes the initialization of Dref, the start of T3XY, the update of Dref, and the start/restart of T3XY.

### (1) Initialization of Dref.

Illustratively, the initialization of Dref may be achieved in any one of the following manners:
in the case that the network device has configured the first criterion for the terminal and the terminal transitions from the RRC non-connected state to the RRC connected state, Dref is set to the real-time distance or the most recently measured distance; or
in the case that the network device has configured the first criterion for the terminal and the terminal starts the timer for monitoring/triggering RLF, Dref is set to the real-time distance or the most recently measured distance.

The real-time distance is the distance between the real-time position of terminal and the serving cell reference point, and the most recently measured distance is the distance between the most recently acquired effective terminal position of terminal and the serving cell reference point.

The real-time distance or the most recently measured distance may be defined as D. The RRC non-connected state includes both the RRC idle state and the RRC inactive state. The timer for monitoring/triggering an RLF may be the T310 timer.

### (2) Start of T3XY.

Illustratively, the start of T3XY may be achieved in any one of the following manners:
in the case that the network device has configured the first criterion for the terminal and the terminal transitions from the RRC non-connected state to the RRC connected state, T3XY is started;
in the case that the network device has configured the first criterion for the terminal, the terminal transitions from the RRC non-connected state to the RRC connected state, and the terminal in the RRC non-connected state does not meet the neighbor cell measurement relaxation criterion, T3XY is started; or
in the case that the network device has configured the first criterion for the terminal and the terminal starts the timer for monitoring/triggering an RLF, T3XY is started.

The RRC non-connected state includes both the RRC idle state and the RRC inactive state. The timer for monitoring/triggering the RLF is the T310 timer.

### (3) Update of Dref and Start/Restart of T3XY.

Illustratively, the update of Dref and the start/restart of T3XY may be achieved in the following manner:
in the case that the variation of the real-time distance is greater than or equal to the first threshold corresponding to the first criterion, Dref is updated to a changed real-time distance, and T3XY is started or restarted; or
in the case that the variation of the most recently measured distance is greater than or equal to the first threshold, Dref is updated to a changed most recently measured distance, and T3XY is started or restarted.

The real-time distance or the most recently measured distance is defined as D, the distance reference value is represented by Dref, the first threshold is represented by s-MeasureDeltaD, and the first timer is represented by T3XY, then:
in the case that (D−Dref)>s-MeasureDeltaD is met, the terminal sets Dref=D and simultaneously starts or restarts T3XY.

Based on the above description, it may be determined whether the terminal meets the first criterion.

In the case that the real-time distance or the most recently measured distance is defined as D, representing the distance reference value by Dref, the first threshold is represented by s-MeasureDeltaD, and the first evaluation duration is represented by t-MeasureDeltaD, then:
in the case that (D−Dref)<=s-MeasureDeltaD within t-MeasureDeltaD, the terminal meets the first criterion;
otherwise, it is considered that the terminal does not meet the first criterion.

In process 13, the terminal initiates the measurement of neighbor cells in the case that the neighbor cell measurement initiation condition is met.

Illustratively, the neighbor cell measurement initiation condition includes at least the following item: the distance variation between the terminal and the serving cell reference point does not meet the first criterion.

In some embodiments, the neighbor cell measurement initiation condition further includes at least one of the following conditions.
Condition 1: The first timer corresponding to the first criterion is running, and the terminal meets the measurement initiation condition corresponding to the s-measure criterion.
Condition 2: The second timer corresponding to the second criterion is running, and the terminal meets the measurement initiation condition corresponding to the s-measure criterion.
Condition 3: The first timer corresponding to the first criterion is running, the second timer corresponding to the second criterion is running, and the terminal meets the measurement initiation condition corresponding to the s-measure criterion.

Using a scenario where the first timer corresponding to the first criterion is represented by T3XY, and the second timer corresponding to the second criterion is represented by T3AB as an example, it should be understood that, combining the multiple conditions provided above, the terminal initiates the measurement of neighbor cells under at least one of the following conditions:
the terminal does not meet the first criterion, T3XY is running, and the terminal meets the measurement initiation condition corresponding to the s-measure criterion;
the terminal does not meet the first criterion or does not meet the second criterion, T3AB is running or T3XY is running, and the terminal meets the measurement initiation condition corresponding to the s-measure criterion; or
the terminal does not meet both the first criterion and the second criterion simultaneously, T3AB is running and T3XY is running, and the terminal meets the measurement initiation condition corresponding to the s-measure criterion.

In some embodiments, the neighbor cell measurement initiation condition adopted by the terminal is configured by the network device.

In some embodiments, in the case that the network device configures both the first criterion and the second criterion for the terminal, the neighbor cell measurement initiation condition adopted by the terminal is determined by the network device through explicit indication information. The explicit indication information is carried in the system broadcast message.

In some embodiments, in the case of no real-time distance and no most recently measured distance, whether to initiate the measurement of neighbor cells is determined by falling back to using the second criterion.

Implementation mode 2: The network device configures the first criterion and the second criterion for the terminal, and the first timer corresponding to the first criterion is the same as the second timer corresponding to the second criterion; whether to initiate the measurement of neighbor cells is determined based on the distance variation between the terminal and the serving cell reference point.

The specific implementation process is as follows.

In process 21, the network device configures the neighbor cell measurement-related information regarding terminals in a connected state for the terminal.

Illustratively, the neighbor cell measurement-related information includes at least one of: a first criterion; a second criterion; or a serving cell reference point.

In some embodiments, the first criterion includes a first threshold, and the second criterion includes a second threshold and a second evaluation duration.

The first threshold is the distance variation threshold corresponding to the first criterion and is represented by s-MeasureDeltaD; the second threshold is the distance variation threshold corresponding to the second criterion and is represented by s-MeasureDeltaP; and the second evaluation duration is represented by t-MeasureDeltaP.

In process 22, the terminal determines whether the first criterion is met based on the distance variation between the terminal and the serving cell reference point.

In some embodiments, the terminal considers that the terminal meets the first criterion in the case that the variation of the distance between the terminal and the serving cell reference point relative to the distance reference value is less than or equal to the first threshold within the second evaluation duration. The terminal meets the first criterion is one of the conditions for not performing the neighbor cell measurement.

The variation of the distance between the terminal and the serving cell reference point relative to the distance reference value includes at least one of: the variation of increase in distance; or the variation of decrease in distance.

Based on the above content, the variation of increase in the distance between the terminal and the serving cell reference point relative to the distance reference value is referred to as the distance increase variation, and the variation of decrease in the distance between the terminal and the serving cell reference point relative to the distance reference value is referred to as the distance decrease variation. Accordingly, the terminal meeting the first criterion includes at least one of the following two situations: the distance increase variation meets the first criterion; or the distance decrease variation meets the first criterion.

In some embodiments, for NB-IoT, the serving cell reference point refers to the reference point corresponding to the anchor carrier.

To determine the distance variation, a distance reference value represented by Dref may be introduced.

Assuming that the first criterion and the second criterion jointly use the T3AB timer, the following describes the initialization of Dref, the update of Dref, and the start/restart of T3AB.

### (1) Initialization of Dref.

Illustratively, the initialization of Dref may be achieved in any one of the following manners:
in the case that the network device has configured the first criterion for the terminal and the terminal transitions from the RRC non-connected state to the RRC connected state, Dref is set to the real-time distance or the most recently measured distance; or
in the case that the network device has configured the first criterion for the terminal and the terminal starts the timer for monitoring/triggering an RLF, Dref is set to the real-time distance or the most recently measured distance.

The real-time distance is the distance between the real-time position of terminal and the serving cell reference point, and the most recently measured distance is the distance between the most recently acquired effective terminal position of terminal and the serving cell reference point.

The real-time distance or the most recently measured distance may be defined as D. The RRC non-connected state includes both the RRC idle state and the RRC inactive state. The timer for monitoring/triggering the RLF may be the T310 timer.

### (2) Update of Dref and Start/Restart of T3AB.

Illustratively, in the case that the third condition is met, Dref is set to the real-time distance or the most recently measured distance, and T3AB is started or restarted.

In some embodiments, the third condition includes: the variation of the RSRP of the terminal on the anchor carrier in the serving cell relative to the RSRP reference value is greater than the RSRP variation threshold.

Illustratively, the variation of the RSRP of the terminal on the anchor carrier in the serving cell relative to the RSRP reference value includes at least one of: the RSRP increase variation, which refers to the variation of increase in the RSRP of the terminal on the anchor carrier in the serving cell relative to the RSRP reference value; or the RSRP decrease variation, which refers to the variation of decrease in the RSRP of the terminal on the anchor carrier in the serving cell relative to the RSRP reference value.

It should be understood that the third condition includes at least one of the following two situations: the RSRP increase variation is greater than the RSRP variation threshold; or the RSRP decrease variation is greater than the RSRP variation threshold.

In some embodiments, in the case of starting or restarting T3AB, the RSRP reference value is updated.

Illustratively, the update of Dref and the start/restart of T3AB may be achieved in any one of the following manners:
in the case that the third condition is met, Dref is updated to the real-time distance or the most recently measured distance, and T3AB is started or restarted;
in the case that the variation of the real-time distance is greater than or equal to the first threshold corresponding to the first criterion, Dref is updated to a changed real-time distance, and T3AB is started or restarted;
in the case that the variation of the most recently measured distance is greater than or equal to the first threshold, Dref is updated to a changed most recently measured distance, and T3AB is started or restarted;
in the case that the third condition is met and the variation of the real-time distance is greater than or equal to the first threshold corresponding to the first criterion, Dref is updated to a changed real-time distance, and T3AB is started or restarted;
in the case that the third condition is met and the variation of the most recently measured distance is greater than or equal to the first threshold, Dref is updated to a changed most recently measured distance, and T3AB is started or restarted;
in the case that the third condition is met or the variation of the real-time distance is greater than or equal to the first threshold corresponding to the first criterion, Dref is updated to a changed real-time distance, and T3AB is started or restarted; or
in the case that the third condition is met or the variation of the most recently measured distance is greater than or equal to the first threshold, Dref is updated to a changed most recently measured distance, and T3AB is started or restarted.

The real-time distance or the most recently measured distance is defined as D, the distance reference value is represented by Dref, the first threshold is represented by s-MeasureDeltaD, and the timer used jointly by the first criterion and the second criterion is represented by T3AB, then:
in the case that RSRPref−(RSRP-PowerOffsetNonAnchor)>s-MeasureDeltaP is met, the terminal sets Dref=D, simultaneously starts or restarts T3AB, and updates RSRPref;
in the case that (D−Dref)>s-MeasureDeltaD is met, the terminal sets Dref=D, simultaneously starts or restarts T3AB, and updates RSRPref;
in the case that RSRPref−(RSRP-PowerOffsetNonAnchor)>s-MeasureDeltaP and (D−Dref)>s-MeasureDeltaD are both met, the terminal sets Dref=D, simultaneously starts or restarts T3AB, and updates RSRPref; or
in the case that RSRPref−(RSRP-PowerOffsetNonAnchor)>s-MeasureDeltaP or (D−Dref)>s-MeasureDeltaD is met, the terminal sets Dref=D, simultaneously starts or restarts T3AB, and updates RSRPref.

The RSRPref indicates the RSRP reference value, the RSRP-PowerOffsetNonAnchor indicates the RSRP of the terminal on the anchor carrier in the serving cell, and the s-MeasureDeltaP indicates the RSRP variation threshold.

Based on the above description, it may be determined whether the terminal meets the first criterion.

The real-time distance or the most recently measured distance is defined as D, the distance reference value is represented by Dref, the first threshold is represented by s-MeasureDeltaD, and the second evaluation duration is represented by t-MeasureDeltaP, then:
in the case that (D−Dref)<=s-MeasureDeltaD within t-MeasureDeltaP, the terminal meets the first criterion;
otherwise, it is considered that the terminal does not meet the first criterion.

In process 23, the terminal initiates the measurement of neighbor cells in the case that the neighbor cell measurement initiation condition is met.

Illustratively, the neighbor cell measurement initiation condition includes at least the following item: the distance variation between the terminal and the serving cell reference point does not meet the first criterion.

In some embodiments, the neighbor cell measurement initiation condition further includes: the second timer corresponding to the second criterion is running, and the terminal meets the measurement initiation condition corresponding to the s-measure criterion.

Using a scenario where the timer used jointly by the first criterion and the second criterion is the T3AB timer as an example, the terminal initiates the measurement of neighbor cells under the following condition: T3AB is running, and the terminal meets the measurement initiation condition corresponding to the s-measure criterion.

Implementation mode 3: The network device configures the third criterion and the fourth criterion for the terminal; whether to initiate the measurement of neighbor cells is determined based on the distance between the terminal and the serving cell reference point.

The specific implementation process is as follows.

In process 31, the network device configures RRM measurement relaxation-related information regarding terminals in a non-connected state for the terminal.

Illustratively, the RRM measurement relaxation-related information includes at least one of: a third criterion; a fourth criterion; or a serving cell reference point.

In some embodiments, the third criterion includes a third threshold; and the fourth criterion includes a fourth threshold.

The third threshold is the distance threshold corresponding to the third criterion and is represented by D_threshold1; the fourth threshold is the distance threshold corresponding to the fourth criterion.

In some embodiments, intra-frequency neighbor cells and inter-frequency neighbor cells correspond to separate third thresholds.

In process 32, the terminal determines whether the first criterion is met based on the distance between the terminal and the serving cell reference point.

In some embodiments, the terminal considers that the terminal meets the third criterion in the case that the distance between the terminal and the serving cell reference point is less than or equal to the third threshold.

In some embodiments, for NB-IoT, the serving cell reference point refers to the reference point corresponding to the anchor carrier.

The distance between the terminal and the serving cell reference point is defined as D, and the third threshold is represented by D_threshold1, then:
in the case that D<D_threshold1 or D<=D_threshold1, the terminal meets the third criterion;
otherwise, it is considered that the terminal does not meet the third criterion.

In process 33, the terminal initiates the measurement of neighbor cells in the case that the neighbor cell measurement initiation condition is met.

Illustratively, the neighbor cell measurement initiation condition includes: in the case that the terminal does not meet the measurement initiation condition corresponding to the s-measure criterion, the terminal initiates the measurement of neighbor cells. The s-measure criterion includes: the third criterion and/or the fourth criterion.

In some embodiments, the terminal not meeting the measurement initiation condition corresponding to the s-measure criterion, includes at least one of the following items: the distance between the terminal and the serving cell reference point does not meet the third criterion; the terminal does not meet the fourth criterion; or the distance between the terminal and the serving cell reference point does not meet the third criterion, and the terminal does not meet the fourth criterion.

In some embodiments, the measurement initiation condition corresponding to the s-measure criterion adopted by the terminal is configured by the network device.

In some embodiments, in the case that the network device configures both the third criterion and the fourth criterion for the terminal, the measurement initiation condition corresponding to the s-measure criterion adopted by the terminal is determined by the network device through explicit indication information.

In some embodiments, the explicit indication information is carried in the system broadcast message.

It should be understood that the terminal initiates the measurement of neighbor cells under at least one of the following conditions:
the terminal does not meet the third criterion:
the terminal does not meet the third criterion or the fourth criterion; or
the terminal does not meet the third criterion and does not meet the fourth criterion.

In the case that the network device only configures the third criterion for the terminal, the network device may instruct the terminal to use the first condition to determine whether to initiate the measurement of neighbor cells. In the case that the network device only configures the fourth criterion for the terminal, the network device may instruct the terminal to use the second condition to determine whether to initiate the measurement of neighbor cells. In the case that the network device configures both the third criterion and the fourth criterion for the terminal, the terminal may use the explicit indication information carried in the system broadcast message to instruct the terminal to use one of the above three conditions for determination.

In some embodiments, in the case of no real-time distance and no most recently measured distance, whether to initiate the measurement of neighbor cells is determined by falling back to using the fourth criterion.

Implementation mode 4: The network device configures a cell service stop time for the terminal, and the terminal initiates the measurement of neighbor cells prior to the cell service stop time.

The specific implementation process is as follows.

In process 41, the network device configures a cell service stop time for the terminal.

Illustratively, the cell service stop time indicates the time when the serving cell in which the terminal is located stops providing services to the coverage area, and may be represented by t-Service.

In some embodiments, the cell service stop time is determined in any one of the following manners:
the existing time parameter for the terminal in an RRC non-connected state to initiate the RRM measurement of neighbor cells is reused; or
considering that the measurement requirements in the RRC connected state and the RRC non-connected state may differ, the network device configures a dedicated time parameter separately for the terminal in an RRC connected state to initiate the RRC measurement of non-serving cells.

In some embodiments, the cell service stop time is transmitted over system broadcast or terminal-specific signaling. The terminal-specific signaling includes at least one of: RRC signaling; or MAC CE signaling.

In process 42, regardless of whether the terminal meets the neighbor cell measurement initiation criterion, the terminal initiates the measurement of neighbor cells prior to the cell service stop time.

For a terminal in an RRC connected state, in the case that the network device has configured the neighbor cell measurement initiation criterion for terminals in the connected state and the network device has configured the cell service stop time for the terminal, then regardless of whether the terminal meets the neighbor cell measurement initiation criterion, the terminal needs to start performing the RRM measurement for neighbor cells prior to the cell service stop time.

In some embodiments, the neighbor cell measurement initiation criterion includes at least one of: a mobility state evaluation criterion; or an s-measure criterion. The mobility state evaluation criterion includes the first criterion and/or the second criterion; and the s-measure criterion includes the third criterion and/or the fourth criterion.

In some embodiments, the time point at which the terminal initiates the measurement of neighbor cells is set according to actual needs. For example, the time point at which the terminal initiates the measurement of neighbor cells depends on the implementation of the terminal.

The following are the apparatus embodiments of the present disclosure. For details not described in the apparatus embodiments, reference may be made to the corresponding descriptions in the above method embodiments. These details are not described herein any further.

FIG. 17 illustrates a structural diagram of an apparatus for neighbor cell measurement in an NTN according to some exemplary embodiments of the present disclosure.

The apparatus includes an initiation module 1720. The initiation module 1720 is configured to initiate the measurement of neighbor cells based on whether the distance and/or the distance variation between a terminal and a serving cell reference point meets a terminal position-based evaluation criterion.

In some embodiments, the initiation module 1720 is configured to initiate the measurement of neighbor cells in the case that the neighbor cell measurement initiation condition is met. The neighbor cell measurement initiation condition includes at least the following item: the distance variation between the terminal and the serving cell reference point does not meet the first criterion, wherein the first criterion is a terminal position-based mobility state evaluation criterion.

In some embodiments, the neighbor cell measurement initiation condition further includes at least one of the following conditions: a first timer corresponding to the first criterion is running, and the terminal meets a measurement initiation condition corresponding to an s-measure criterion; a second timer corresponding to a second criterion is running, and the terminal meets the measurement initiation condition corresponding to the s-measure criterion; or the first timer corresponding to the first criterion is running, a second timer corresponding to a second criterion is running, and the terminal meets the measurement initiation condition corresponding to the s-measure criterion. The second criterion is a channel quality-based mobility state evaluation criterion.

In some embodiments, the first timer corresponding to the first criterion is different from the second timer corresponding to the second criterion.

In some embodiments, the apparatus further includes a setting module 1740. The setting module 1740 is configured to set a distance reference value to a real-time distance or a most recently measured distance in the case that a first condition is met. The distance reference value is used to determine the distance variation between the terminal and the serving cell reference point, the real-time distance is a distance between a real-time position of terminal and the serving cell reference point, and the most recently measured distance is a distance between a most recently acquired effective terminal position of terminal and the serving cell reference point.

In some embodiments, the first condition includes at least one of the following items: a network device has configured the first criterion for the terminal, and the terminal transitions from an RRC non-connected state to an RRC connected state; or a network device has configured the first criterion for the terminal, and the terminal starts a timer for monitoring/triggering an RLF.

In some embodiments, the setting module 1740 is further configured to start the first timer corresponding to the first criterion in the case that a second condition is met.

In some embodiments, the second condition includes at least one of the following items: the network device has configured the first criterion for the terminal, and the terminal transitions from the RRC non-connected state to the RRC connected state; the network device has configured the first criterion for the terminal, the terminal transitions from the RRC non-connected state to the RRC connected state, and the terminal in the RRC non-connected state does not meet the neighbor cell measurement relaxation criterion; or the network device has configured the first criterion for the terminal, and the terminal starts the timer for monitoring/triggering an RLF.

In some embodiments, the setting module 1740 is further configured to update the distance reference value to a changed real-time distance and start or restart the first timer corresponding to the first criterion in the case that the variation of the real-time distance is greater than or equal to the first threshold corresponding to the first criterion; or update the distance reference value to a changed most recently measured distance and start or restart the first timer corresponding to the first criterion in the case that the variation of the most recently measured distance is greater than or equal to the first threshold. The distance reference value is used to determine the distance variation between the terminal and the serving cell reference point, the real-time distance is the distance between the real-time position of terminal and the serving cell reference point, and the most recently measured distance is the distance between the most recently acquired effective terminal position of terminal and the serving cell reference point.

In some embodiments, the first criterion corresponds to the first evaluation duration and the first threshold, and the initiation module 1720 is further configured to determine that the distance variation meets the first criterion in the case that the distance variation between the terminal and the serving cell reference point is less than or equal to the first threshold within the first evaluation duration. The distance variation is determined based on the distance reference value.

In some embodiments, the duration of the first timer corresponding to the first criterion is the first evaluation duration.

In some embodiments, the apparatus further includes a reception module 1760. The reception module 1760 is configured to receive a first criterion form the network device, wherein the first criterion corresponds to a first evaluation duration and a first threshold.

In some embodiments, the first evaluation duration is determined in one of the following manners: the network device configures the first evaluation duration for the terminal; or the terminal determines the first evaluation duration based on the second evaluation duration, wherein the second evaluation duration is the evaluation duration corresponding to the second criterion.

In some embodiments, the reception module 1760 is further configured to receive a second criterion and/or a serving cell reference point from the network device, wherein the second criterion is a channel quality-based mobility state evaluation criterion.

In some embodiments, the second criterion includes at least one of: a second threshold; or a second evaluation duration.

In some embodiments, the initiation module 1720 is further configured to determine whether to initiate the measurement of neighbor cells by falling back to using the second criterion in the case of no real-time distance and no most recently measured distance. The real-time distance is the distance between the real-time position of terminal and the serving cell reference point, and the most recently measured distance is the distance between the most recently acquired effective terminal position of terminal and the serving cell reference point.

In some embodiments, the neighbor cell measurement initiation condition adopted by the terminal is configured by the network device.

In some embodiments, in the case that the network device configures both the first criterion and the second criterion for the terminal, the neighbor cell measurement initiation condition adopted by the terminal is determined by the network device through explicit indication information.

In some embodiments, the explicit indication information is carried in the system broadcast message.

In some embodiments, the neighbor cell measurement initiation condition further includes: the second timer corresponding to the second criterion is running, and the terminal meets the measurement initiation condition corresponding to the s-measure criterion, wherein the second criterion is a channel quality-based mobility state evaluation criterion.

In some embodiments, the first timer corresponding to the first criterion is the same as the second timer corresponding to the second criterion.

In some embodiments, the setting module 1740 is further configured to set the distance reference value to the real-time distance or the most recently measured distance in the case that the first condition is met. The distance reference value is used to determine the distance between the terminal and the serving cell reference point, the real-time distance is the distance between the real-time position of terminal and the serving cell reference point, and the most recently measured distance is the distance between the most recently acquired effective terminal position of terminal and the serving cell reference point.

In some embodiments, the first condition includes at least one of the following items: the network device has configured the first criterion for the terminal, and the terminal transitions from the RRC non-connected state to the RRC connected state; or the network device has configured the first criterion for the terminal, and the terminal starts the timer for monitoring/triggering an RLF.

In some embodiments, the setting module 1740 is further configured to: in the case that the third condition is met, update the distance reference value to the real-time distance or the most recently measured distance and start or restart the timer used jointly by the first criterion and the second criterion; or in the case that the variation of the real-time distance is greater than or equal to the first threshold corresponding to the first criterion, update the distance reference value to a changed real-time distance and start or restart the timer used jointly by the first criterion and the second criterion; or in the case that the variation of the most recently measured distance is greater than or equal to the first threshold, update the distance reference value to a changed most recently measured distance and start or restart the timer used jointly by the first criterion and the second criterion; or in the case that the third condition is met and the variation of the real-time distance is greater than or equal to the first threshold corresponding to the first criterion, update the distance reference value to a changed real-time distance and start or restart the timer used jointly by the first criterion and the second criterion; or in the case that the third condition is met and the variation of the most recently measured distance is greater than or equal to the first threshold, update the distance reference value to a changed most recently measured distance and start or restart the timer used jointly by the first criterion and the second criterion; or in the case that the third condition is met and the variation of the real-time distance is greater than or equal to the first threshold corresponding to the first criterion, update the distance reference value to a changed real-time distance and start or restart the timer used jointly by the first criterion and the second criterion; or in the case that the third condition is met and the variation of the most recently measured distance is greater than or equal to the first threshold, update the distance reference value to a changed most recently measured distance and start or restart the timer used jointly by the first criterion and the second criterion. The distance reference value is used to determine the distance between the terminal and the serving cell reference point, the real-time distance is the distance between the real-time position of terminal and the serving cell reference point, and the most recently measured distance is the distance between the most recently acquired effective terminal position of terminal and the serving cell reference point.

In some embodiments, the setting module 1740 is further configured to update the RSRP reference value in the case of restarting the timer used jointly by the first criterion and the second criterion.

In some embodiments, the third condition includes: the variation of the RSRP of the terminal on the anchor carrier in the serving cell relative to the RSRP reference value is greater than the RSRP variation threshold.

In some embodiments, the first criterion corresponds to the first threshold, and the initiation module 1720 is further configured to determine that the distance variation meets the first criterion in the case that the distance variation between the terminal and the serving cell reference point is less than or equal to the first threshold within the second evaluation duration. The distance variation is determined based on the distance reference value, and the second evaluation duration is the evaluation duration corresponding to the second criterion.

In some embodiments, the duration of the timer used jointly by the first criterion and the second criterion is the second evaluation duration.

In some embodiments, the reception module 1760 is further configured to receive a first criterion from the network device, wherein the first criterion corresponds to a first threshold.

In some embodiments, the reception module 1760 is further configured to receive a second criterion and/or a serving cell reference point from the network device, wherein the second criterion is a channel quality-based mobility state evaluation criterion.

In some embodiments, the second criterion includes at least one of: a second threshold; or a second evaluation duration.

In some embodiments, the initiation module 1720 is further configured to initiate the measurement of neighbor cells in the case that the distance between the terminal and the serving cell reference point does not meet a third criterion, wherein the third criterion is a terminal position-based s-measure criterion.

In some embodiments, the third criterion corresponds to a third threshold, and the initiation module 1720 is further configured to determine that the terminal meets the third criterion in the case that the distance between the terminal and the serving cell reference point is less than or equal to the third threshold.

In some embodiments, intra-frequency neighbor cells and inter-frequency neighbor cells correspond to separate third thresholds.

In some embodiments, the initiation module 1720 is configured to initiate the measurement of neighbor cells in the case that the terminal does not meet the measurement initiation condition corresponding to the s-measure criterion. The s-measure criterion includes the third criterion and/or the fourth criterion, wherein the fourth criterion is the channel quality-based s-measure criterion.

In some embodiments, the terminal not meeting the measurement initiation condition corresponding to the s-measure criterion, includes at least one of the following items: the distance between the terminal and the serving cell reference point does not meet the third criterion; the terminal does not meet the fourth criterion; or the distance between the terminal and the serving cell reference point does not meet the third criterion, and the terminal does not meet the fourth criterion.

In some embodiments, the measurement initiation condition corresponding to the s-measure criterion adopted by the terminal is configured by the network device.

In some embodiments, in the case that the network device configures both the third criterion and the fourth criterion for the terminal, the measurement initiation condition corresponding to the s-measure criterion adopted by the terminal is determined by the network device through explicit indication information.

In some embodiments, the explicit indication information is carried in the system broadcast message.

In some embodiments, the initiation module 1720 is further configured to determine whether to initiate the measurement of neighbor cells by falling back to using the fourth criterion in the case of no real-time distance and no most recently measured distance. The real-time distance is the distance between the real-time position of terminal and the serving cell reference point, and the most recently measured distance is the distance between the most recently acquired effective terminal position of terminal and the serving cell reference point.

In some embodiments, the reception module 1760 is further configured to receive the third criterion from the network device and receive the fourth criterion and/or the serving cell reference point from the network device, wherein the fourth criterion is the channel quality-based s-measure criterion.

In some embodiments, the third criterion includes a third threshold.

In some embodiments, the serving cell reference point refers to the reference point corresponding to the anchor carrier.

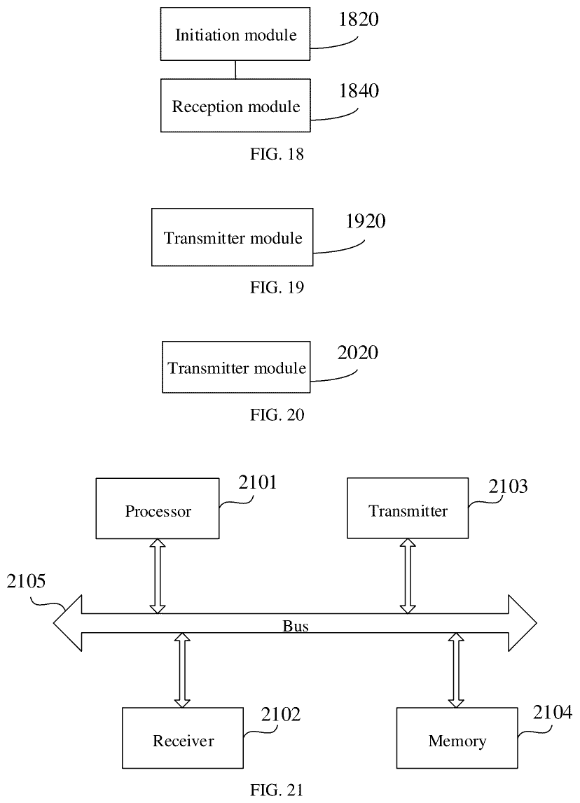

FIG. 18 illustrates a schematic diagram of an apparatus for neighbor cell measurement in an NTN according to some exemplary embodiments of the present disclosure.

The apparatus includes an initiation module 1820. The initiation module 1820 is configured to initiate the measurement of neighbor cells prior to a cell service stop time, wherein the cell service stop time indicates the time when the serving cell in which the terminal is located stops providing services to the coverage area.

In some embodiments, the cell service stop time is one of: a time parameter for the terminal in an RRC non-connected state to initiate the RRM measurement of neighbor cells; or a dedicated time parameter for the terminal in an RRC connected state to initiate the RRC measurement of non-serving cells.

In some embodiments, the initiation module 1820 is configured to initiate the measurement of neighbor cells prior to the cell service stop time regardless of whether the terminal meets the neighbor cell measurement initiation criterion.

In some embodiments, the neighbor cell measurement initiation criterion includes at least one of: a mobility state evaluation criterion; or an s-measure criterion.

In some embodiments, the mobility state evaluation criterion includes at least one of: a first criterion, which is the terminal position-based mobility state evaluation criterion; or a second criterion, which is the channel quality-based mobility state evaluation criterion.

In some embodiments, the s-measure criterion includes at least one of: a third criterion, which is the terminal position-based s-measure criterion; or a fourth criterion, which is the channel quality-based s-measure criterion.

In some embodiments, the apparatus further includes a reception module 1840. The reception module is configured to receive the cell service stop time from the network device.

In some embodiments, the cell service stop time is transmitted over system broadcast or terminal-specific signaling.

In some embodiments, the terminal-specific signaling includes at least one of: RRC signaling; or MAC CE signaling.

FIG. 19 illustrates a schematic diagram of an apparatus for neighbor cell measurement in an NTN according to some exemplary embodiments of the present disclosure.

The apparatus includes a transmitter module 1920. The transmitter module 1920 is configured to transmit a terminal position-based evaluation criterion to the terminal, wherein the terminal position-based evaluation criterion is configured for the terminal to determine whether to initiate the measurement of neighbor cells based on whether the distance and/or the distance variation between the terminal and the serving cell reference point meets the terminal position-based evaluation criterion.

In some embodiments, the transmitter module 1920 is configured to transmit a first criterion to the terminal, wherein the first criterion is a terminal position-based mobility state evaluation criterion.

In some embodiments, the transmitter module 1920 is further configured to transmit a distance reference value to the terminal, wherein the distance reference value is used to determine the distance variation of the distance between the terminal and the serving cell reference point.

In some embodiments, the transmitter module 1920 is further configured to transmit a second criterion to the terminal, wherein the second criterion is a channel quality-based mobility state evaluation criterion.

In some embodiments, the first timer corresponding to the first criterion is different from the second timer corresponding to the second criterion.

In some embodiments, the first criterion corresponds to a first evaluation duration and a first threshold.

In some embodiments, the first timer corresponding to the first criterion is the same as the second timer corresponding to the second criterion.

In some embodiments, the first criterion corresponds to a first threshold.

In some embodiments, the transmitter module 1920 is configured to transmit a third criterion to the terminal, wherein the third criterion is a terminal position-based s-measure criterion.

In some embodiments, the third criterion includes a third threshold.

In some embodiments, the transmitter module 1920 is configured to transmit a third criterion to the terminal, wherein the third criterion includes the third threshold corresponding to intra-frequency neighbor cells and the third threshold corresponding to inter-frequency neighbor cells.

In some embodiments, the transmitter module 1920 is further configured to transmit a fourth criterion to the terminal, wherein the fourth criterion is a channel quality-based s-measure criterion.

In some embodiments, the transmitter module 1920 is further configured to transmit a serving cell reference point to the terminal, wherein the serving cell reference point is used by the terminal to determine whether the distance or the distance variation between the terminal and the serving cell reference point meets the terminal position-based evaluation criterion.

FIG. 20 illustrates a schematic diagram of an apparatus for neighbor cell measurement in an NTN according to some exemplary embodiments of the present disclosure.

The apparatus includes a transmitter module 2020. The transmitter module 2020 is configured to transmit a cell service stop time to the terminal, wherein the cell service stop time indicates the time when the serving cell in which the terminal is located stops providing services to the coverage area, and the cell service stop time is used for the terminal to initiate the measurement of neighbor cells prior to the cell service stop time.

In some embodiments, the cell service stop time is one of: a time parameter for the terminal in an RRC non-connected state to initiate the radio resource management (RRM) measurement of neighbor cells; or a dedicated time parameter for the terminal in an RRC connected state to initiate the RRC measurement of non-serving cells.

In some embodiments, the cell service stop time is transmitted over system broadcast or terminal-specific signaling.

In some embodiments, the terminal-specific signaling includes at least one of: RRC signaling; or MAC CE signaling.

FIG. 21 illustrates a schematic structural diagram of a communication device (a terminal or a network device) according to some exemplary embodiments of the present disclosure. The communication device includes: a processor 2101, a receiver 2102, a transmitter 2103, a memory 2104, and a bus 2105.

The processor 2101 includes one or more processing cores, and the processor 2101 runs various functional applications and performs information processing by running software programs and modules.

The receiver 2102 and the transmitter 2103 are implemented as a communication assembly, which may be a communication chip.

The memory 2104 is connected to the processor 2101 through the bus 2105.

The memory 2104 is configured to store at least one instruction, and the processor 2101, when loading and executing the at least one instruction, is caused to perform the processes of the method for neighbor cell measurement in an NTN in the above method embodiments.

In addition, the memory 2104 may be practiced by any type of volatile or non-volatile storage devices or combination thereof. The volatile or non-volatile storage device includes, but not limited to: a disk or optical disc, an electrically-erasable programmable read-only memory (EEPROM), an erasable programmable read-only memory (EPROM), a static random access memory (SRAM), a read-only memory (ROM), a magnetic memory, a flash memory, or a programmable read-only memory (PROM).

The embodiments of the present disclosure further provide a terminal. The terminal includes a processor, and the processor is configured to initiate measurement of neighbor cells based on whether a distance and/or a distance variation between a terminal and a serving cell reference point meets a terminal position-based evaluation criterion.

The embodiments of the present disclosure further provide a terminal. The terminal includes a processor, and the processor is configured to initiate the measurement of neighbor cells prior to a cell service stop time, wherein the cell service stop time indicates a time when the serving cell in which the terminal is located stops providing services to the coverage area.

The embodiments of the present disclosure further provide a network device. The network device includes a processor, and the processor is configured to transmit a terminal position-based evaluation criterion to the terminal, wherein the terminal position-based evaluation criterion is configured for the terminal to determine whether to initiate the measurement of neighbor cells based on whether the distance and/or the distance variation between the terminal and the serving cell reference point meets the terminal position-based evaluation criterion.

The embodiments of the present disclosure further provide a network device. The network device includes a processor, and the processor is configured to transmit a cell service stop time to the terminal, wherein the cell service stop time indicates the time when the serving cell in which the terminal is located stops providing services to the coverage area, and the cell service stop time is used for the terminal to initiate the measurement of neighbor cells prior to the cell service stop time.

The embodiments of the present disclosure further provide a computer-readable storage medium storing one or more computer programs. The one or more computer programs, when loaded and run by a processor, cause the processor to perform the method for neighbor cell measurement in an NTN as described above.

The embodiments of the present disclosure further provide a chip including one or more programmable logic circuits and/or one or more program instructions. The chip, when running, is caused to perform the method for neighbor cell measurement in an NTN as described above.

The embodiments of the present disclosure further provide a computer program product or a computer program. The computer program product or the computer program includes one or more computer instructions stored in a computer-readable storage medium. The one or more computer instructions, when read from the computer-readable storage medium and executed by a processor, cause the processor to perform the method for neighbor cell measurement in an NTN as described above.

Described above are merely exemplary embodiments of the present disclosure and are not intended to limit the present disclosure. Any modifications, equivalent substitutions, improvements, and the like, made within the spirit and principle of the present disclosure should fall within the protection scope of the present disclosure.

1. A method for neighbor cell measurement in a non-terrestrial network (NTN), applicable to a terminal, the method comprising:
initiating measurement of neighbor cells based on whether at least one of a distance or a distance variation between the terminal and a serving cell reference point meets a terminal position-based evaluation criterion.

2. The method according to claim 1, wherein initiating the measurement of the neighbor cells based on whether at least one of the distance or the distance variation between the terminal and the serving cell reference point meets the terminal position-based evaluation criterion comprises:
initiating the measurement of the neighbor cells in a case that the distance between the terminal and the serving cell reference point does not meet a third criterion;
wherein the third criterion is a terminal position-based s-measure criterion.

3. The method according to claim 2, wherein the third criterion corresponds to a third threshold, and the method further comprises:
in a case that the distance between the terminal and the serving cell reference point is less than or equal to the third threshold, determining that the terminal meets the third criterion.

4. The method according to claim 2, wherein initiating the measurement of the neighbor cells in the case that the distance between the terminal and the serving cell reference point does not meet the third criterion comprises:
initiating the measurement of the neighbor cells in a case that the terminal does not meet a measurement initiation condition corresponding to an s-measure criterion;
wherein the s-measure criterion comprises at least one of the third criterion or a fourth criterion, wherein the fourth criterion is a channel quality-based s-measure criterion.

5. The method according to claim 4, wherein the terminal not meeting the measurement initiation condition corresponding to the s-measure criterion comprises at least one of the following items:
the distance between the terminal and the serving cell reference point does not meet the third criterion;
the terminal does not meet the fourth criterion; or
the distance between the terminal and the serving cell reference point does not meet the third criterion and the terminal does not meet the fourth criterion.

6. The method according to claim 5, wherein the measurement initiation condition corresponding to the s-measure criterion adopted by the terminal is configured by a network device.

7. The method according to claim 2, further comprising:
receiving the third criterion from a network device and receiving at least one of a fourth criterion or the serving cell reference point from the network device, wherein the fourth criterion is a channel quality-based s-measure criterion.

8. The method according to claim 7, wherein the third criterion comprises a third threshold.

9. A method for neighbor cell measurement in a non-terrestrial network (NTN), applicable to a terminal, the method comprising:
initiating measurement of neighbor cells prior to a cell service stop time, wherein the cell service stop time indicates a time when a serving cell in which the terminal is located stops providing services to a coverage area.

10. The method according to claim 9, wherein the cell service stop time is one of:
a time parameter for a terminal in a radio resource control (RRC) non-connected state to initiate radio resource management (RRM) measurement of neighbor cells; or
a dedicated time parameter for a terminal in an RRC connected state to initiate RRC measurement of non-serving cells.

11. The method according to claim 9, wherein initiating the measurement of the neighbor cells prior to the cell service stop time comprises:
initiating, regardless of whether the terminal meets a neighbor cell measurement initiation criterion, the measurement of the neighbor cells prior to the cell service stop time.

12. The method according to claim 11, wherein the neighbor cell measurement initiation criterion comprises at least one of:
a mobility state evaluation criterion; or
an s-measure criterion.

13. The method according to claim 12, wherein the mobility state evaluation criterion comprises at least one of:
a first criterion, wherein the first criterion is a terminal position-based mobility state evaluation criterion; or
a second criterion, wherein the second criterion is a channel quality-based mobility state evaluation criterion.

14. The method according to claim 12, wherein the s-measure criterion comprises at least one of:
a third criterion, wherein the third criterion is a terminal position-based s-measure criterion; or
a fourth criterion, wherein the fourth criterion is a channel quality-based s-measure criterion.

15. The method according to claim 9, further comprising:
receiving the cell service stop time from a network device.

16. The method according to claim 15, wherein the cell service stop time is transmitted over system broadcast or terminal-specific signaling.

17. A terminal, comprising: a processor; wherein
the processor is configured to initiate measurement of neighbor cells based on whether at least one of a distance or a distance variation between the terminal and a serving cell reference point meets a terminal position-based evaluation criterion.

18. The terminal according to claim 17, wherein the processor is configured to:
initiate the measurement of the neighbor cells in a case that the distance between the terminal and the serving cell reference point does not meet a third criterion;
wherein the third criterion is a terminal position-based s-measure criterion.

19. The terminal according to claim 18, wherein the third criterion corresponds to a third threshold, and the processor is further configured to:
in a case that the distance between the terminal and the serving cell reference point is less than or equal to the third threshold, determine that the terminal meets the third criterion.

20. The terminal according to claim 18, wherein the processor is configured to:
initiate the measurement of the neighbor cells in a case that the terminal does not meet a measurement initiation condition corresponding to an s-measure criterion;
wherein the s-measure criterion comprises at least one of the third criterion or a fourth criterion, wherein the fourth criterion is a channel quality-based s-measure criterion.
